(19) United States
(12) Patent Application Publication
(10) Pub. No.: US 2026/0217120 A1
(43) Pub. Date: Jul. 30, 2026

(54) SYSTEM AND METHOD FOR PROVIDING AUGMENTED REALITY NAVIGATION SCREEN FOR AGRICULTURAL VEHICLE

(71) Applicant: GINT CO., LTD., Gyeonggi-do (KR)

(72) Inventors: Gwon Young KIM, Seoul (KR); Yong Hyeon KIM, Busan (KR); Seung Rak SON, Gyeonggi-do (KR)

(73) Assignee: GINT CO., LTD., Gyeonggi-do (KR)

(21) Appl. No.: 19/576,955

(22) Filed: Mar. 24, 2026

Related U.S. Application Data
(63) Continuation of application No. PCT/KR2024/012322, filed on Aug. 20, 2024.

(30) Foreign Application Priority Data
Sep. 26, 2023 (KR) 10-2023-0129142

(51) Int. Cl. B60K 35/28; A01B 76/00; B60K 35/10; B60K 35/22; G06T 11/00

(52) U.S. Cl. CPC B60K 35/28; A01B 76/00; B60K 35/10; B60K 35/22; G06T 11/00; B60K 2360/1438; B60K 2360/166; G06T 2200/24

(57) ABSTRACT

Embodiments relate to a system and method for providing an augmented reality (AR) navigation screen in an agricultural vehicle, including obtaining (i) GPS location information indicating a GPS location of the agricultural vehicle through a GPS module, (ii)navigation information of the agricultural vehicle, (iii) a driving environment image capturing a driving environment in which the agricultural vehicle is traveling through a camera module, calculating driving-related information of the agricultural vehicle based on the GPS location information of the agricultural vehicle obtained while traveling, obtaining a difference between a driving guidance route and an actual driving route of the agricultural vehicle as driving error information of the agricultural vehicle, and generating an AR navigation screen including an AR graphic object visually representing at least one of the navigation information, the driving-related information of the agricultural vehicle, and the driving error information.

### CROSS-REFERENCE TO RELATED APPLICATION(S

This application is a continuation of PCT Patent Application Serial No. PCT/KR2024/012322, filed August 20, 2024, entitled "System and Method for Providing an Augmented Reality Navigation Screen for Agricultural Vehicles," which claims priority to Korean Patent Application Serial No. 10-2023-0129142, filed September 26, 2023. All sections of the aforementioned application(s) are incorporated herein by reference in their entirety.

### FIELD OF THE DISCLOSURE

Embodiments of the present disclosure relate to providing an augmented reality (AR) navigation screen for an agricultural vehicle.

### BACKGROUND

With the advancement of autonomous driving technology and wireless communication technology, there has been an increasing number of attempts to attach an autonomous driving device to an agricultural vehicle and to autonomously drive the agricultural vehicle by utilizing GPS data and other sensing data through the autonomous driving device. However, since autonomous driving technology has not yet been advanced to the level of full autonomy, an operator may be required to ride in or walk alongside an autonomously driving agricultural vehicle. It may be necessary to provide driving-related information to operators using autonomous agricultural vehicles.

With recent advancements in augmented reality (AR) technology, there has been growing activity in the automotive sector to provide navigation information through Head-up Display (HUD) technology that projects driving routes onto the real background. AR and VR technologies, which bridge the real world and virtual reality, serve as a medium for providing more convenient and accurate guidance to users in the navigation field. Although the two technologies are technically distinct, both contribute to accelerating the advancement of navigation technology and improving the user experience.

Augmented reality (AR) technology is a field that enhances real-world experience by combining virtual elements with the real environment. This technology uses cameras and sensors to detect the surrounding environment and, based on this detection, provides virtual graphics, audio, and information in real time. Users can view the real world and virtual elements together, enabling interaction and access to information. AR technology is primarily utilized in navigation, gaming, education, healthcare, marketing, and other fields, and is implemented in various forms through AR glasses, smartphone applications, and the like. By fusing the real environment with a virtual world, AR technology delivers an immersive experience, and with advances in computer vision and sensing technology, it is realizing increasingly realistic and diverse capabilities. However, compared to the automotive industry, tractor manufacturers have been slower to adopt AR technologies such as HUD, and to date still primarily present routes using virtual graphics or satellite maps.

Meanwhile, for conventional ride-on agricultural vehicles or autonomous agricultural vehicles, a technology for accurately determining the location (positioning) of the agricultural vehicle is indispensably required. GNSS (Global Navigation Satellite System) is the most widely used positioning system. GNSS is a general term for systems that use satellites to provide information on the position, altitude, and velocity of objects on the ground, with the United States' GPS (Global Positioning System) being the most representative example. In a general environment, GPS-based map matching algorithms leveraging big data can be used to estimate the precise location and travel path of a vehicle. However, in environments where agricultural vehicles operate, applying such map matching algorithms is difficult. As a result, situations occasionally arise where accurate route recognition is difficult due to a discrepancy between the navigation route and actual reality.

Accordingly, there is a need for User Experience (UX)/User Interface (UI) technology that, in an autonomous driving environment for agricultural vehicles, efficiently provides an operator with the error between the GPS location of an autonomously driving agricultural vehicle and the vehicle's position on a map as driving-related information, and further enables efficient autonomous driving by accurately matching the GPS location of the autonomous agricultural vehicle with its map-based position.

### SUMMARY

Based on the discussion described above, embodiments of the present disclosure aim to provide a system and method for providing an AR navigation screen for an agricultural vehicle, in order to efficiently provide an operator with various driving-related information including the error between the GPS location of the agricultural vehicle and the map-based position of the agricultural vehicle.

In addition, embodiments of the present disclosure aim to provide a system and method capable of accurately matching the GPS location of an autonomously driving agricultural vehicle with the map-based position of the autonomously driving agricultural vehicle, by calibrating the error between the GPS location and the map-based position of the autonomously driving agricultural vehicle from the displayed driving-related information of the agricultural vehicle.

According to various embodiments of the present disclosure, a method for providing an augmented reality (AR) navigation screen may be performed by a system for providing an augmented reality (AR) navigation screen installed in an agricultural vehicle. The method may comprise: obtaining GPS location information indicating a GPS location of the agricultural vehicle from a GPS module; obtaining navigation information of the agricultural vehicle, wherein the navigation information includes driving guidance route information describing a driving guidance route along which the agricultural vehicle is to travel; obtaining a driving environment image capturing a driving environment in which the agricultural vehicle is traveling from a camera module; calculating driving-related information of the agricultural vehicle based on the GPS location information of the agricultural vehicle obtained while the agricultural vehicle is traveling; obtaining a difference between the driving guidance route and an actual driving route of the agricultural vehicle as driving error information of the agricultural vehicle; and generating at least one AR graphic object visually representing at least one of the navigation information, the driving-related information of the agricultural vehicle, and the driving error information, and generating an AR navigation screen in which the AR graphic object is arranged on the driving environment image.

In one embodiment, the generating of the AR navigation screen may comprise: identifying a location of a graphic object representing two or more of the navigation information, the driving-related information, and the driving error information, wherein the location of the AR graphic object is a location on the driving environment image; defining a shape space of each graphic object based on the identified location, and generating a shape of the AR graphic object based on the defined shape space; and overlaying the shape of the AR graphic object onto the identified location on the driving environment image to generate the AR navigation screen in which the shape of the AR graphic object is represented on the driving environment image.

In one embodiment, the AR graphic object may include a first graphic object visually representing the driving guidance route. The identifying of the location of the AR graphic object on the driving environment image may comprise: identifying a location of the first graphic object based on the GPS location information of the agricultural vehicle, map information of a geographical area including the GPS location of the agricultural vehicle, driving heading information of the agricultural vehicle, and parameters of the camera module. The identifying of the location of the first graphic object may comprise: mapping a 2D coordinate system for the driving environment image and a 3D coordinate system for a virtual 3D world; calculating a 3D location of the driving guidance route in the virtual 3D world based on the map information and the driving guidance route information; and changing the 3D location of the driving guidance route to a 2D location of the driving guidance route through a mapping relationship between the 2D coordinate system and the 3D coordinate system, and identifying the changed 2D location as the location of the first graphic object.

In one embodiment, the mapping of the 2D coordinate system for the driving environment image and the 3D coordinate system for the virtual 3D world may comprise: setting intrinsic parameters of the camera module to map 2D coordinates of the driving environment image and virtual 3D world coordinates. The intrinsic parameters of the camera module may include at least one of a principal point, a focal length, and distortion coefficients.

In one embodiment, the driving-related information may include at least one of driving mode information, a driving route traveled along the driving guidance route, a driving distance according to the driving route, a driving time, a real-time driving speed of the agricultural vehicle at a current location at a time of generating the AR navigation screen, a driving azimuth angle of the agricultural vehicle, and work coverage area information. The AR graphic object may further include at least one of a second graphic object visually representing the work coverage area according to the driving of the agricultural vehicle, a third graphic object visually representing a driving direction, and a fourth graphic object visually representing the driving error information. The identifying of the location of the AR graphic object on the driving environment image may comprise: when the AR graphic object includes the second graphic object, identifying a location of the second graphic object based on the identified location of the first graphic object, driving route information, driving distance information, and pre-stored unit work coverage area information per unit driving distance; when the AR graphic object includes the third graphic object, identifying a location of the third graphic object based on the identified location of the first graphic object and the driving heading information; and when the AR graphic object includes the fourth graphic object, identifying a location of the fourth graphic object based on the identified location of the first graphic object and the driving error information. The locations of the second graphic object, the third graphic object, and the fourth graphic object are locations on the 2D coordinate system for the driving environment image.

In one embodiment, the generating of the AR navigation screen may further comprise: generating a map view area indicating the GPS location information of the agricultural vehicle, a map image, the driving heading information of the agricultural vehicle, the work coverage area information, and a surrounding area of the agricultural vehicle; generating an error view area describing a current driving error of the agricultural vehicle at the time of generating the AR navigation screen based on the driving error information; and overlaying at least one of the map view area and the error view area onto the driving environment image to generate the AR navigation screen in which at least one of the map view area and the error view area is displayed.

In one embodiment, the generating of the AR navigation screen may further comprise: displaying the driving distance information of the agricultural vehicle within the calculated driving-related information, an area of the work coverage area, and the driving time information in a first sub-area of the navigation screen; displaying the driving mode information of the agricultural vehicle in a second sub-area of the navigation screen; and displaying contents of a driving guidance message within the obtained navigation information in a sub-area of the navigation screen.

In one embodiment, the method may further comprise: to remove the driving error of the agricultural vehicle, displaying an AB driving reference line on a calibration interface screen including a map image on which the agricultural vehicle is shown based on the GPS location of the agricultural vehicle, and calibrating the GPS coordinates of the agricultural vehicle to actual coordinates of the agricultural vehicle using the AB driving reference line. The AB driving reference line is at least a partial route among the driving guidance route in the navigation information. In order to indicate the driving error of the agricultural vehicle modified according to the calibration result on the AR navigation screen, the AR graphic object indicating the driving error of the agricultural vehicle modified according to the calibration result on the AR navigation screen is relatively reduced compared to before the calibration.

In one embodiment, the calibrating may comprise: displaying a reference line moving icon overlaid on the AB driving reference line on an interface screen for calibration; moving the reference line moving icon displayed on the interface screen for calibration in response to a user input to the interface screen for calibration; and when the reference line moving icon displayed on the interface screen for calibration is moved within a preset movement section in response to the user input to the interface screen for calibration, additionally displaying an AB driving reference line moving indicator on the interface screen for calibration. The AB driving reference line moving indicator is located in an outer area of a left area and a right area on the interface screen for calibration, and when the movement of the reference line moving icon is made outside the preset movement section, the display of the AB driving reference line moving indicator is deactivated. The user input to the interface screen for calibration is a user's touch input for a preset area based on a touch interface embedded in the interface screen for calibration, and the left area or the right area relative to the AB driving reference line on the interface screen for calibration is an area set to receive the user's touch input; when the user's touch input is made on the left area, the reference line moving icon is moved to the left by a preset distance, and when the user's touch input is made on the right area, the reference line moving icon is moved to the right by a preset distance. The AB driving reference line moving indicator includes an auxiliary AB driving reference line, which becomes a reference for moving an auxiliary moving line icon, and the auxiliary moving line icon; the auxiliary AB driving reference line and the auxiliary moving line icon are displayed together on the interface screen for calibration along with the AB driving reference line. The auxiliary AB driving reference line is displayed in a center of the AB driving reference line moving indicator, and the auxiliary moving line icon moves in response to a touch input to the left area or the right area causing the movement of the reference line moving icon in the AB driving reference line moving indicator.

In one embodiment, in the displaying of the AB driving reference line on the calibration interface screen including the map image on which the agricultural vehicle is shown based on the GPS location of the agricultural vehicle: when a calibration button for triggering calibration displayed on the map is input, a modal for calibration is overlaid and displayed on the map. The AB driving reference line, the reference line moving icon, and the AB driving reference line moving indicator are displayed on the modal for calibration, and the left area and the right area are located on the modal.

A non-transitory computer-readable recording medium according to another aspect of the present disclosure may record a program for performing the method for providing an augmented reality (AR) navigation screen according to the above-described embodiments.

A navigation system for generating an augmented reality (AR) navigation screen according to still another aspect of the present disclosure is installed in an agricultural vehicle. The navigation system comprising a processor and a memory storing instructions, wherein the instructions, when executed by the processor, cause the navigation system to perform: obtaining GPS location information indicating a GPS location of the agricultural vehicle from a GPS module; obtaining navigation information of the agricultural vehicle, wherein the navigation information includes driving guidance route information describing a driving guidance route along which the agricultural vehicle is to travel; obtaining a driving environment image capturing a driving environment in which the agricultural vehicle is traveling from a camera module; calculating driving-related information of the agricultural vehicle based on the GPS location information of the agricultural vehicle obtained while the agricultural vehicle is traveling; obtaining a difference between the driving guidance route and an actual driving route of the agricultural vehicle as driving error information of the agricultural vehicle; and generating at least one AR graphic object visually representing at least one of the navigation information, the driving-related information of the agricultural vehicle, and the driving error information, and generating an AR navigation screen in which the AR graphic object is arranged on the driving environment image.

According to various embodiments of the present disclosure, a system for displaying driving-related information of an agricultural vehicle uses augmented reality technology to generate various driving-related information — including the error between the GPS location of an autonomously driving agricultural vehicle and the map-based position of the autonomously driving agricultural vehicle in an autonomous driving environment — as augmented reality objects, and outputs an augmented reality calibration interface screen on which the augmented reality objects are arranged on a driving image, thereby efficiently providing an operator with various driving-related information.

Specifically, a driver of an agricultural vehicle can check an accurate driving route that corresponds to reality through a real-time front/rear display screen utilizing AR technology. This allows the user to receive more intuitive and accurate guidance compared to conventional navigation systems that have a large visual discrepancy from reality, and enables an increase in the autonomous driving and work efficiency of a tractor. The navigation screen combines real-time video and driving information through AR technology so that the user can confirm an accurate driving route without any sense of disconnect. The user is configured to check, through the display screen, all information essential to the driving situation, including the driving route. Since the route is overlaid onto the actual environment through graphics, accurate guidance is provided to the user to support effective operation. As a result, utilizing the AR navigation screen provides the advantage of allowing the user to intuitively grasp information by realistically displaying the real-time driving route and related information of a tractor performing agricultural work. This has the effect of improving the usability of tractor autonomous driving and agricultural work.

In addition, the system for displaying driving-related information of the agricultural vehicle can match the GPS location with the map-based position of the autonomously driving agricultural vehicle using the AB driving reference line. In this process, even a first-time user can clearly and intentionally move the AB driving reference line to a desired position without difficulty, resulting in the effect of increasing the usability of the application.

The effects obtainable from the present disclosure are not limited to the effects mentioned above, and other effects not mentioned will be clearly understood by those skilled in the art to which the present disclosure belongs from the description below.

### BRIEF DESCRIPTION OF THE DRAWINGS

FIG. 1 is a network environment diagram of a system for providing an AR navigation screen for an agricultural vehicle, according to various embodiment of the present disclosure described herein.

FIG. 2 is a configuration diagram of an AR system according to various embodiments of the present disclosure described herein.

FIG. 3 illustrates a first display unit and a second display unit according to various embodiments of the present disclosure described herein.

FIG. 4 depicts an illustrative embodiment of a method for providing an augmented reality navigation screen for an agricultural vehicle according to various aspect of the present disclosure described herein.

FIG. 5 depicts an illustrative embodiment of another method for generating an AR navigation screen in which the AR graphic object is presented on the driving environment image, according to various embodiments of the present disclosure described herein.

FIG. 6 illustrates an exemplary, non-limiting embodiment of an AR navigation screen according to various embodiments of the present disclosure described herein.

FIG. 7 illustrates an exemplary, non-limiting embodiment of components of a map view area according to various embodiments of the present disclosure described herein.

FIG. 8 illustrates an exemplary, non-limiting embodiment of an AR navigation screen displaying the rear of an agricultural vehicle, according to various embodiments of the present disclosure described herein.

FIG. 9 depicts an illustrative embodiment of further another method for removing a driving error of the agricultural vehicle by providing a GUI for AB driving reference line calibration on a display in connection with a generating step (S800) shown in FIG. 4, according to various embodiments of the present disclosure described herein.

FIG. 10 illustrates an exemplary, non-limiting embodiment of a calibration interface screen according to various embodiments of the present disclosure described herein.

FIG. 11 depicts an illustrative embodiment of a calibrating step (S830) shown in FIG. 9 according to various embodiments of the present disclosure described herein.

FIG. 12 illustrates an exemplary screen displaying a reference line moving icon overlaid on the AB driving reference line shown in FIG. 10.

FIG. 13 illustrates direct input of a movement distance of a reference line moving icon on a calibration interface screen, according to various embodiments of the present disclosure.

FIG. 14 depicts another illustrative embodiment of a calibrating step shown in FIG. 9 according to various embodiments of the present disclosure described herein.

FIG. 15 depicts an illustrative embodiment of a calibration interface screen on which an auxiliary moving line icon and an auxiliary AB driving reference line are displayed, according to various embodiments of the present disclosure described herein.

FIG. 16 illustrates a direct input of a movement distance of the auxiliary moving line icon on the calibration interface screen of FIG. 15.

### DETAILED DESCRIPTION

Hereinafter, embodiments and examples of the present disclosure will be described in detail with reference to the accompanying drawings so that those skilled in the art to which the present disclosure belongs may easily practice the same. However, the present disclosure may be implemented in various different forms and is not limited to the embodiments and examples described herein.

Specific structural or functional descriptions of the embodiments are disclosed for illustrative purposes only, and may be modified and implemented in various forms. Accordingly, the embodiments are not limited to a specific disclosed form, and the scope of the present specification should be understood to include various modifications, equivalents, and/or alternatives included within the technical spirit.

Although terms such as first and second may be used to describe various components, such terms should be interpreted only for the purpose of distinguishing one component from another. For example, a first component may be referred to as a second component, and similarly, a second component may be referred to as a first component. Expressions such as "first," "second," "firstly," or "secondly" used in various embodiments may modify various components regardless of order and/or importance, and do not limit the corresponding components.

When a component is referred to as being "connected to" another component, it should be understood that the component may be directly connected or coupled to the other component, but another component may exist therebetween.

A singular expression includes a plural expression unless the context clearly indicates otherwise. In the present specification, terms such as "comprise" or "have" are intended to specify the presence of a described feature, number, step, operation, component, part, or combination thereof, and should not be understood to preclude the possibility of the presence or addition of one or more other features, numbers, steps, operations, components, parts, or combinations thereof.

Unless otherwise defined, all terms used herein, including technical or scientific terms, have the same meanings as generally understood by those skilled in the art to which the present disclosure belongs. Terms generally defined in dictionaries should be interpreted as having meanings consistent with the contextual meanings of the related technology, and unless expressly defined in the present specification, should not be interpreted in an ideally or excessively formal sense.

The expression "configured to" as used herein may be interchangeably used with, for example, "suitable for," "having the capacity to," "designed to," "adapted to," "made to," or "capable of," depending on the context. The term "configured to" may not necessarily mean "specifically designed to" in hardware terms. Instead, in some contexts, the expression "a device configured to" may mean that the device "is capable of" performing a certain operation together with other devices or components. For example, the phrase "a processor configured to perform A, B, and C" may refer to a dedicated processor (e.g., an embedded processor) for performing the corresponding operations, or a general-purpose processor (e.g., a CPU or application processor) capable of performing the corresponding operations by executing one or more software programs stored in a memory device.

Agricultural machines are treated as a very important element to reduce the high labor burden and production costs in response to labor shortages due to the decline in the rural working population and aging.

As used herein, an agricultural machine refers to equipment for performing various tasks necessary for farming — such as plowing, rotary cultivation, pest control, and transplanting — and is divided into walk-behind work machines operated by a worker walking alongside the agricultural machine, and agricultural vehicles (or riding-type work machines) in which a worker sits on a driver's seat provided on the agricultural machine and operates the same.

Various embodiments of the present disclosure disclose a device applicable to an agricultural vehicle classified as a riding-type work machine such as a tractor.

The agricultural vehicle may be combined with a working device to perform work on agricultural land such as a rice paddy or field. The traveling of the agricultural vehicle involves such agricultural work.

A user of the agricultural vehicle may perform manual driving control directly. The user of the agricultural vehicle may directly manipulate a shuttle lever of the agricultural vehicle to control the forward or rearward movement of the agricultural vehicle, and may manipulate a steering wheel to control a route of the agricultural vehicle.

In various embodiments of the present disclosure, an agricultural vehicle may be a non-autonomously driving agricultural vehicle that relies entirely on an operator for driving functions, or an autonomously driving agricultural vehicle that performs the driving functions at least partially by a pre-installed autonomous driving program (or semi-autonomous driving program).

If the agricultural vehicle is an autonomously driving agricultural vehicle, a driving control device for controlling forward or rearward driving may be installed on the agricultural vehicle for autonomous driving of the agricultural vehicle. In this case, the agricultural vehicle may move along a set route and may move forward or rearward according to a setting of the user of the agricultural vehicle. Autonomous driving may be controlled and set through information exchange between the driving control device installed on the agricultural vehicle and a user device. By using a user device such as a smartphone or computer, which is a terminal capable of performing information calculations and transmitting or receiving information, the user may generate autonomous driving-related setting information and transmit the generated information to the driving control device. The driving control device includes a transceiver and a processor and is electrically connected to a driving unit of the agricultural vehicle to control the driving unit. The driving control device may receive the autonomous driving-related setting information from the user device and control the forward or rearward movement of the driving unit of the agricultural vehicle according to the autonomous driving-related setting information.

For autonomous driving of the agricultural vehicle, a steering wheel control device for controlling the steering wheel may be additionally installed on the agricultural vehicle. In this case, the steering wheel control device may be configured to control the steering wheel such that the agricultural vehicle may move along a set route according to the autonomous driving-related setting information received from the user device. The steering wheel control device may be mechanically connected to the steering wheel and configured to rotate the steering wheel according to a set route. The steering wheel control device may include a transceiver to receive the autonomous driving-related setting information from the user device. The steering wheel control device may include a processor and perform rotation control of the steering wheel according to the autonomous driving-related setting information.

Hereinafter, for purposes of description, a system and method for providing an AR navigation screen for an agricultural vehicle will be described in greater detail using embodiments in which an autonomously driving agricultural vehicle is used. However, in the embodiments according to the system and method, the agricultural vehicle is not limited to the autonomously driving agricultural vehicle, and it will be apparent to those skilled in the art that the present disclosure is also applicable to a non-autonomously driving agricultural vehicle capable of generating and outputting augmented reality objects using augmented reality technology, and matching the GPS location of the agricultural vehicle with the map-recognized position of the agricultural vehicle.

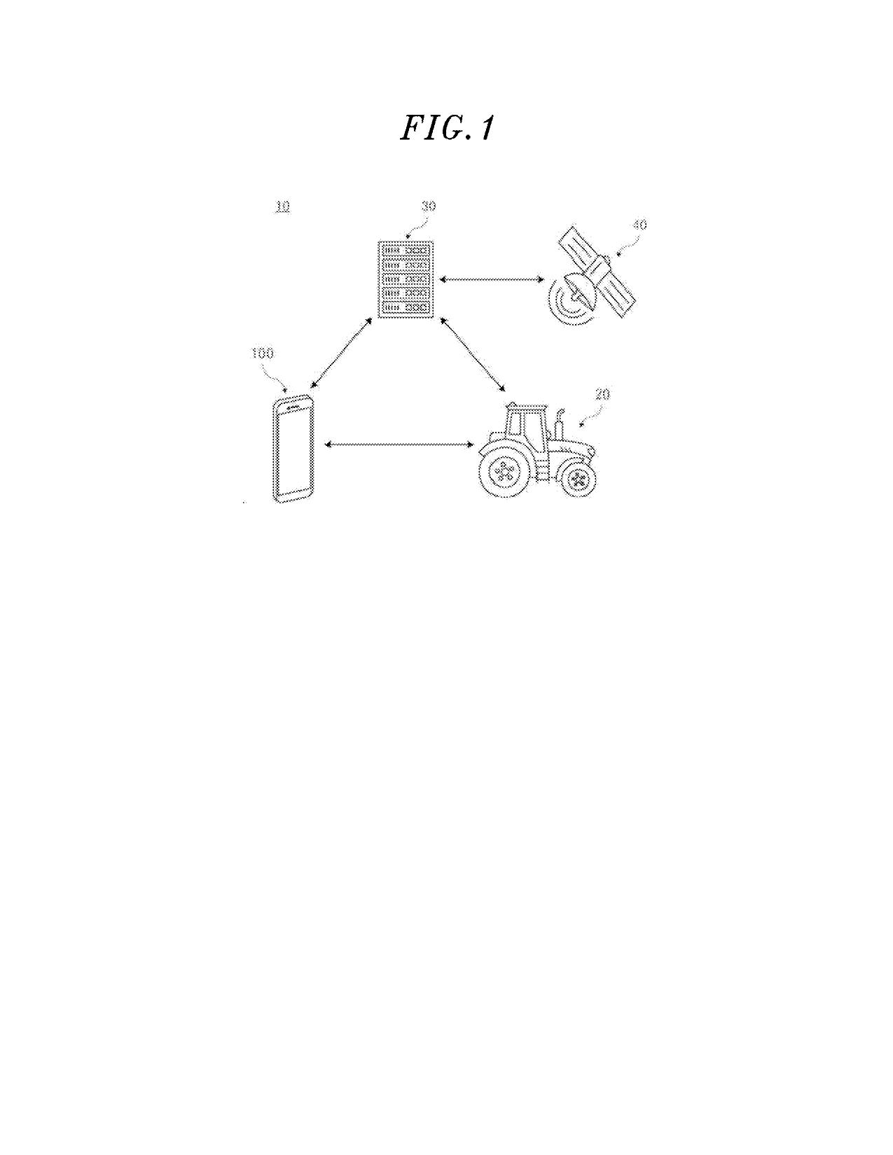

FIG. 1 is a network environment diagram of a system 10 for providing an AR navigation screen for an agricultural vehicle, according to one aspect of the present disclosure. Referring to FIG. 1, the system 10 for providing a navigation service to the agricultural vehicle may include a system for providing an AR navigation screen installed in the agricultural vehicle (hereinafter, AR system 20), a network computing device 30 connected to communicate with the AR system 20 to transmit and receive data via a communication network, and a satellite 40. In addition, in some embodiments, the system 10 for providing a navigation service to the agricultural vehicle may further include a user terminal 100.

The user terminal 100 may be a computing system that includes hardware, software, or embedded logic components, or a combination of two or more of these components, and is capable of performing appropriate functions implemented or supported by the device. The user terminal 100 may be implemented in the form of a computer system such as, for example, a desktop computer, a laptop computer, a netbook, a tablet computer, an e-book reader, a GPS device, a camera, a personal digital assistant (PDA), a portable electronic device, a cellular phone, a smartphone, other computing devices, other mobile devices, other wearable devices, other appropriate electronic devices, or any appropriate combination thereof.

A user may remotely receive, through the user terminal 100, an AR navigation screen and navigation information, driving-related information, and autonomous driving information displayed on the AR navigation screen. In addition, the user may control the autonomous driving operation of the agricultural vehicle by inputting autonomous driving instructions through the user terminal 100.

The user terminal 100 may be configured to execute a dedicated application or web-based interface to interoperate with the AR system 20 and/or the network computing device 30. In some embodiments, the user terminal 100 may receive and display information associated with operation of the agricultural vehicle, including an AR navigation screen and/or driving-related information (e.g., navigation information, driving-related information, driving error information, and autonomous driving-related information). In some embodiments, the user terminal 100 may transmit user inputs to the agricultural vehicle and/or the AR system 20, including autonomous driving control commands, navigation setting information, and/or calibration-related inputs. In some embodiments, the user terminal 100 may output a calibration interface screen for AB driving reference line calibration and provide a touch-based user interface for moving a reference line moving icon and completing calibration.

The agricultural machine on which the AR system 20 is installed is a riding-type agricultural machine and may be various agricultural vehicles such as a tractor. For example, an agricultural vehicle 20 may perform agricultural work or civil engineering work while towing a working machine. The agricultural vehicle 20 may provide strong traction to tow heavy loads and may provide multiple gear stages to perform various tasks. In addition, the working machine may include implements for performing various agricultural tasks, such as, for example, spades, plows, harrows, rakes, rotavators, and harvesters. Depending on the type of working machine coupled to the agricultural vehicle 20, the agricultural vehicle 20 may perform various agricultural tasks such as tillage, soil crushing, pest control, water pumping, and threshing.

As described above, the agricultural machine on which the AR system 20 is installed may be an autonomously driving agricultural machine configured to perform autonomous driving or an autonomous driving operation that assists the driving of an operator (i.e., a user). When the agricultural machine on which the AR system 20 is installed is an autonomously driving agricultural machine, the AR system 20 may be implemented by interoperating with an autonomous driving control system or by being integrated into a single system.

The AR system 20 according to the embodiments may be entirely hardware, entirely software, or may have aspects that are partly hardware and partly software. For example, a device (or system) may collectively refer to hardware equipped with data processing capability and operating software for driving the hardware. As used herein, terms such as "unit," "system," and "device" are intended to refer to a combination of hardware and software driven by the hardware. For example, the hardware may be a data processing device including a Central Processing Unit (CPU), a Graphic Processing Unit (GPU), or other processors. In addition, software may refer to a running process, an object, an executable, a thread of execution, a program, and the like.

The AR system 20 includes at least one processor capable of processing data, a memory storing data, and a communication unit transmitting and receiving data. The AR system 20 may acquire a map image including at least one map element from the network computing device 30 or the satellite 40. The map image may represent a geographical area through map elements.

The AR system 20 may be configured to perform a navigation operation by setting a driving guidance route (e.g., an autonomous driving route) of the agricultural vehicle on the acquired map image and guiding the agricultural vehicle along the set driving guidance route. To this end, the AR system 20 may include a navigation application capable of performing navigation operations, or may be connected to a third-party system that provides navigation services. For example, the AR system 20 may include a navigation application programming interface (API) for connecting to a third-party system that provides navigation services.

The AR system 20 is configured to generate an AR navigation screen that displays driving-related information of the agricultural machine using augmented reality (AR) technology, and to provide the generated AR navigation screen to the user. Navigation information and driving-related information of the agricultural machine may be provided to the user through the AR navigation screen.

In addition, in various embodiments of the present disclosure, the AR system 20 may be configured such that the actual position of the agricultural vehicle is accurately displayed on the map image. If the position of the agricultural vehicle is not accurately displayed, a discrepancy between the position of the agricultural vehicle displayed on the AR navigation screen based on the GPS location information and the actual position will inevitably occur. This discrepancy goes beyond merely providing an incorrect position of the agricultural vehicle, and may also cause various related information derived based on the position of the agricultural vehicle (e.g., work coverage area, etc.) to be provided with incorrect values. To address the discrepancy, the AR system 20 may be configured to provide a graphic user interface (GUI) for accurately displaying and calibrating the position of the agricultural vehicle on a map image, to a first display device that provides the AR navigation screen, a second display device different from the first display device, or the user terminal 100. Specifically, the user may calibrate the position of the agricultural vehicle to be accurately identified using a map displayed on various display devices and an AB driving reference line displayed on the map image.

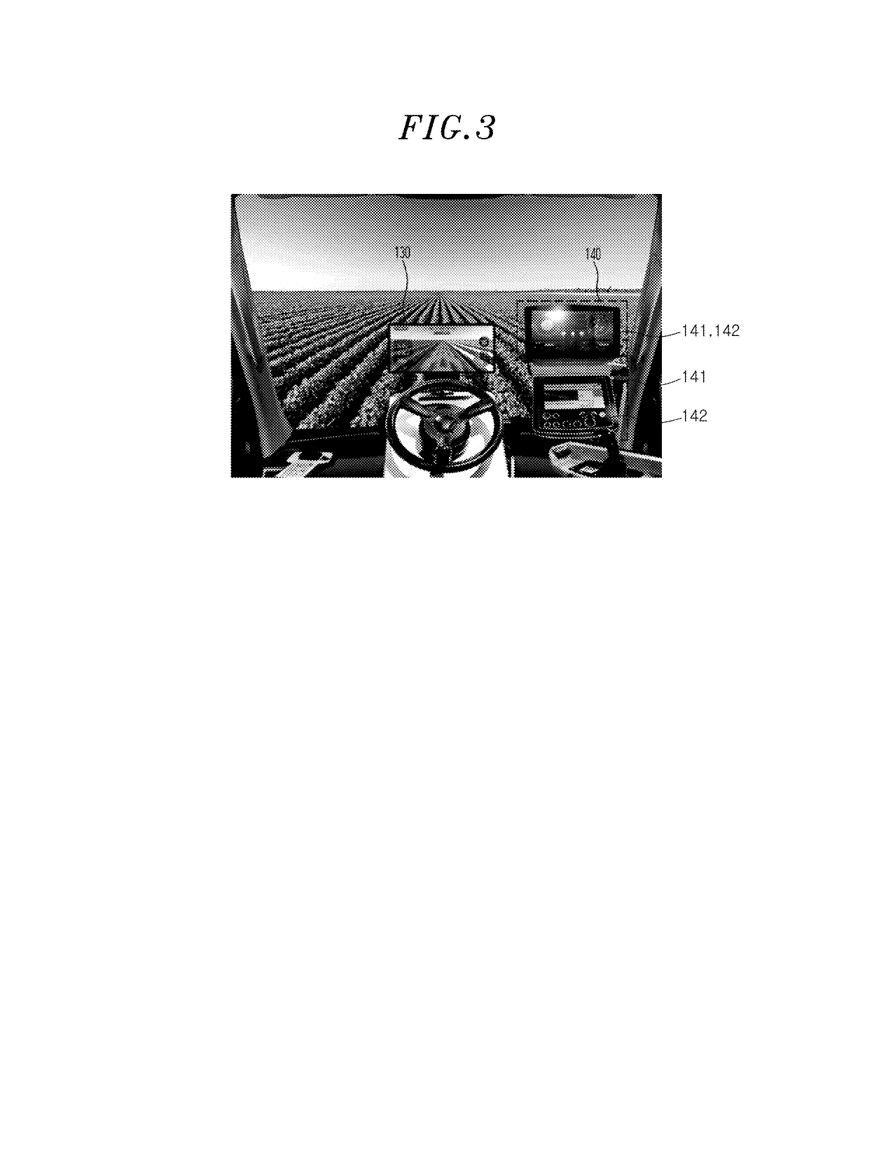

Although the AR system 20 is illustrated in the present disclosure as a device separate from the agricultural vehicle, it will be apparent to those skilled in the art that in alternative embodiments, the AR system 20 may be a device included in or attached to the agricultural vehicle. The configuration and operation of the AR system 20 will be described in greater detail with reference to FIGS. 3 through 16 below.

In various embodiments, the network computing device 30, the satellite 40, and the user terminal 100 may also be connected to transmit and receive data via a communication network. The network may be implemented as one or more types of any data communication network, such as 3G, 4G, 5G, LAN, WAN, the Internet, telephone networks, cable networks, peer-to-peer networks, mesh networks, satellite communications, and other wired/wireless communication networks. In some embodiments, the communication network may include one or more of Bluetooth, Bluetooth Low Energy (BLE), Wi-Fi, Wi-Fi Direct, ZigBee, near-field communication (NFC), ultra-wideband (UWB), and/or Ethernet. In some embodiments, the communication network may support communication using one or more protocols, including Transmission Control Protocol/Internet Protocol (TCP/IP), User Datagram Protocol (UDP), Hypertext Transfer Protocol (HTTP/HTTPS), and/or Message Queuing Telemetry Transport (MQTT). In some embodiments, the network may be configured to support vehicle-to-everything (V2X) communication, including vehicle-to-network (V2N), vehicle-to-infrastructure (V2I), and/or vehicle-to-device (V2D) communication, to enable low-latency transmission of navigation information, map data, calibration-related data, and/or autonomous driving-related information.

The network computing device 30 may include a local server or a cloud server that provides services of the system 10 for providing an AR navigation screen for an agricultural vehicle according to various embodiments of the present disclosure. The network computing device 30 may provide to the AR system 20 a dedicated application installed in the AR system 20 programmed to perform operations for providing an AR navigation screen for an agricultural vehicle, or a map corresponding to the position of the agricultural vehicle. Image data of the map of the network computing device 30 may be received from the satellite 40.

In some embodiments, when the agricultural vehicle is an autonomously driving agricultural vehicle, the network computing device 30 may be a server capable of providing autonomous driving-based services. To this end, the network computing device 30 may provide autonomous driving services through its own autonomous driving program, or may be connected to a server operated by an external autonomous driving company. The server 30 may transmit autonomous driving-related information of the agricultural vehicle 20 to the agricultural vehicle 20 and the user terminal 100 via a communication network, and may receive information from the agricultural vehicle 20 and the user terminal 100 via a communication network.

The satellite 40 may be a device that provides satellite map imagery for actual terrain or data necessary for GPS positioning required for the services of the system 10 for providing an AR navigation screen for an agricultural vehicle according to various embodiments of the present disclosure. In some embodiments, the satellite 40 may include one or more Earth observation satellites configured to capture and provide satellite-captured images (e.g., optical imagery, infrared imagery, or multispectral imagery) usable as map images, and/or one or more positioning satellites configured to broadcast navigation signals for determining location information of the agricultural vehicle. In some embodiments, the satellite 40 may provide one or more of ephemeris data, almanac data, correction data, and timing information to support GNSS-based positioning (e.g., GPS, GLONASS, Galileo, and/or BeiDou). In some embodiments, the satellite map imagery may be provided directly to the AR system 20 and/or indirectly via the network computing device 30, and may be updated periodically or on-demand based on the GPS location of the agricultural vehicle.

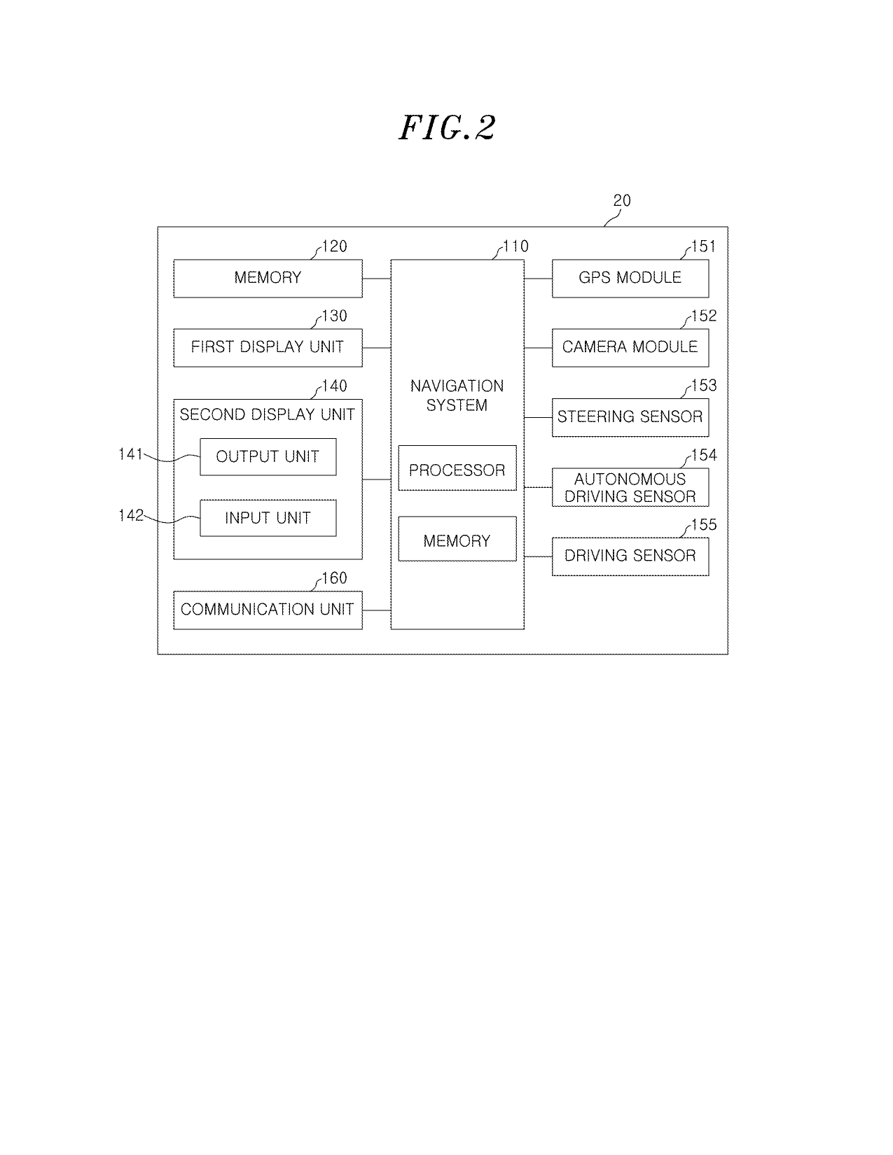

FIG. 2 is a configuration diagram of the AR system 20 according to various embodiments of the present disclosure. Referring to FIG. 2, the AR system 20 includes a navigation system 110, a memory 120, a first display unit 130, a second display unit 140, a GPS module 151, a camera module 152, and a communication unit 160. In some embodiments, the AR system 20 may further include a steering sensor 153, an autonomous driving sensor 154, and/or a driving sensor 155.

The navigation system 110 may be implemented as at least one processor. The processor may include any combination of a CPU, graphical processing units (GPUs), a single-core processor, a multi-core processor, application specific integrated circuits (ASICs), and the like. The processor may be implemented in software and/or firmware in addition to a hardware implementation. A software or firmware implementation of the processor may be described in any appropriate programming language and may include computer- or machine-executable instructions for performing the various functions described above. The software implementation of the processor may be stored in whole or in part in the memory 120.

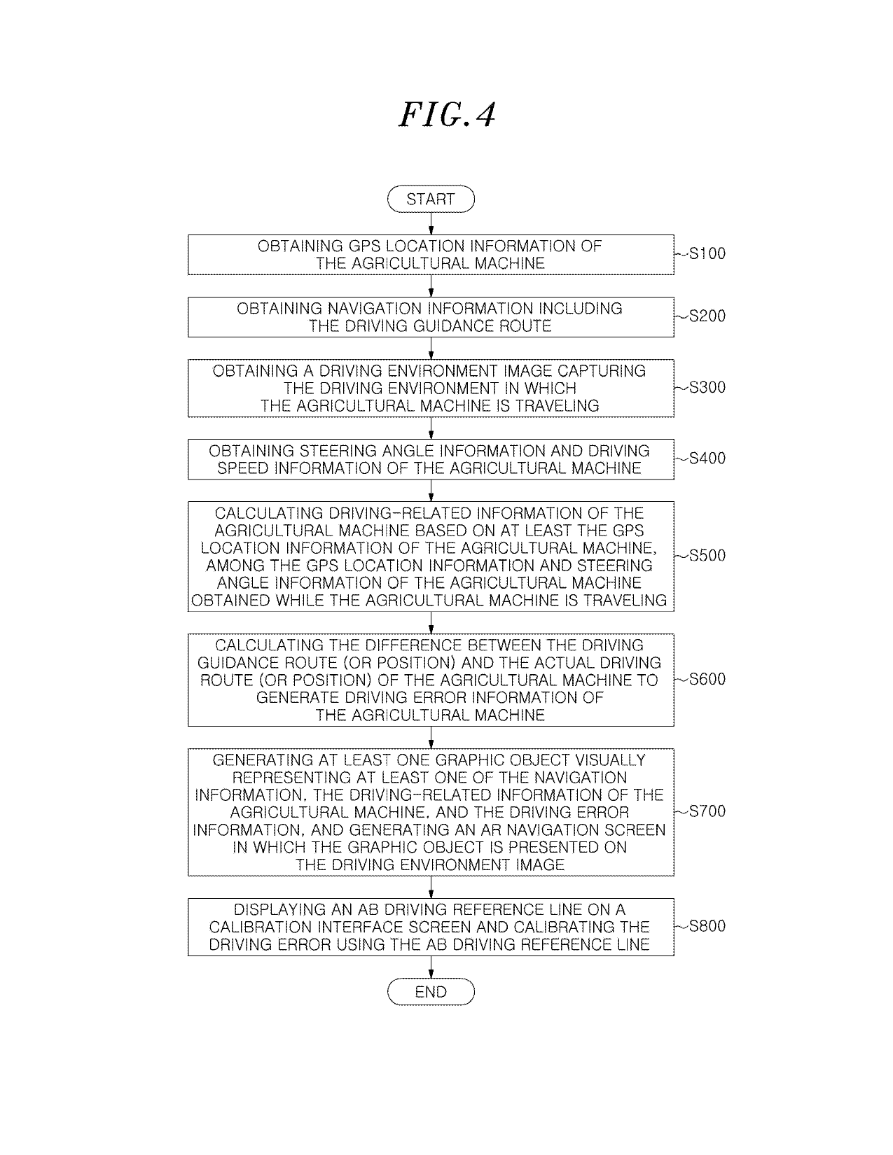

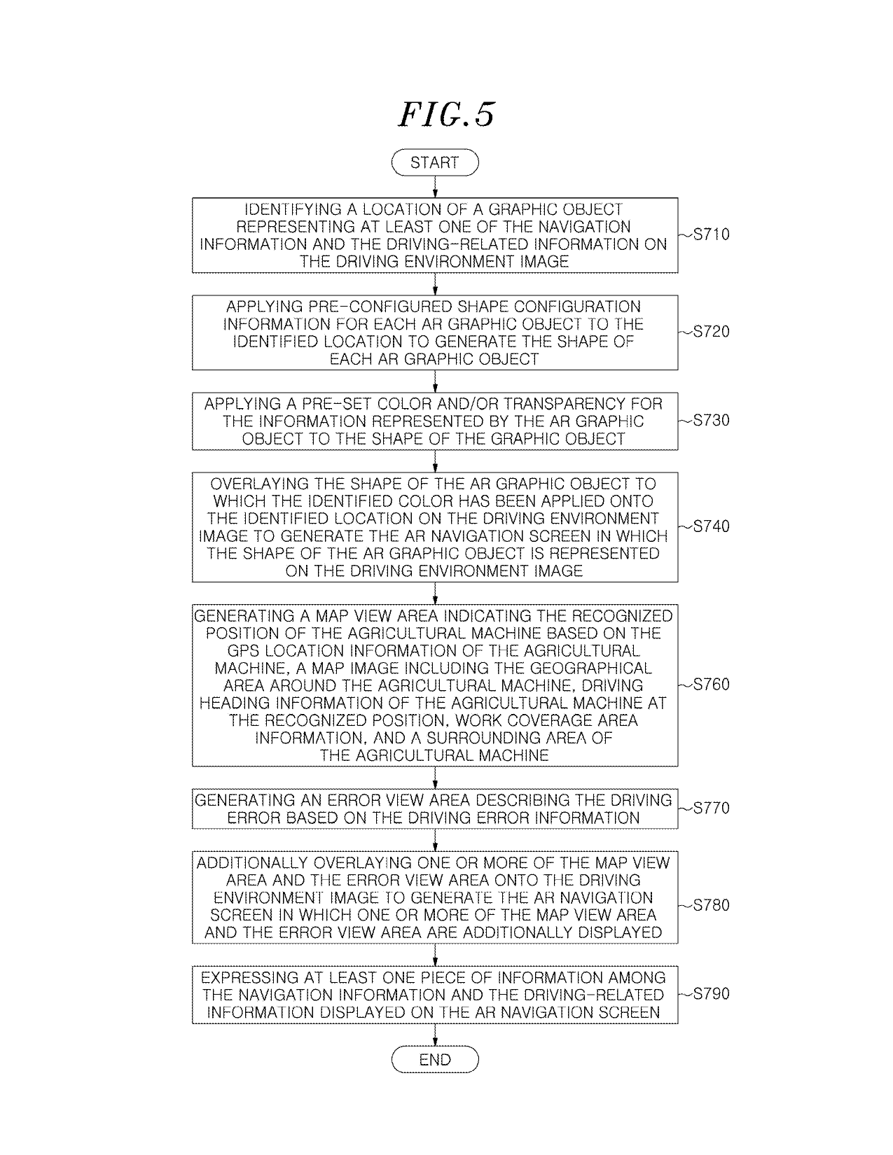

The navigation system 110 may be configured to generate an AR navigation screen that represents at least one of navigation information, driving-related information, and driving error information as an AR graphic object. The process by which the navigation system 110 generates the AR navigation screen will be described in greater detail with reference to FIGS. 4 and 5 below.

The memory 120 may store a program of instructions that may be loaded and executed on the processor, and data generated during execution of these programs. Examples of programs and data stored on the memory 120 may include an operating system that controls the operation of hardware and software resources available in the AR system 20, drivers for interacting with hardware devices such as the agricultural vehicle and the network computing device 30, communication protocols for exchanging data with other hardware devices such as the agricultural vehicle and the network computing device 30, and additional software applications. The memory 120 may be volatile (such as RAM) or non-volatile (such as ROM or flash memory). The memory 120 may provide storage for computer-readable instructions, data structures, program modules, and other data. Computer-readable media may include at least two types of computer-readable media: computer storage media and communication media.

In addition, the memory 120 may store a map image and map information corresponding to the map image. In some embodiments, the map image may include one or more of satellite imagery, aerial imagery, and/or vector-based map tiles, and may be cached for a geographical region around a current GPS location of the agricultural vehicle and/or along a planned driving guidance route. In some embodiments, the map information may include metadata associated with the map image, including georeferencing information (e.g., coordinate system, scale, and tile indices), map elements (e.g., boundaries of fields, roads, contour lines, obstacles, and landmarks), and/or attribute information associated with the map elements. In some embodiments, the map information may further include one or more of elevation information, surface type information, and work-area information usable for generating or refining AR graphic objects and/or for map matching between a GPS-based position and a map-based position. In some embodiments, the memory 120 may store update information for periodically refreshing the map image and the map information, and may store a history of map images and/or map information corresponding to previously traveled routes.

FIG. 3 illustrates a first display unit 130 and a second display unit 140 according to various embodiments of the present disclosure. Referring to FIG. 3, the first display unit 130 is an output device that displays the AR navigation screen. The second display unit 140 may display user inputs for control of the agricultural vehicle, control results, work results, vehicle status, and various contents provided by an infotainment system. In various embodiments of the present disclosure, the second display unit 140 may include an output device 141 and an input device 142, as shown in FIG. 2.

The output devices 141 of the first display unit 130 and the second display unit 140 may be implemented as a liquid crystal display (LCD), organic light emitting diodes (OLED), active matrix organic light emitting diodes (AMOLED), or the like. The display units 130 and 140 visually provide to the user data stored in or input to the AR system 20. In various embodiments of the present disclosure, the second display unit 140 may display an AB driving reference line on a map and a map image by executing at least one application, and may provide a GUI displaying various objects, modals, and indicators for calibrating the AB driving reference line.

As shown in FIG. 2, the input device 142 is a component configured to receive commands related to user input. The input device 142 may include a touch unit or other input units. The touch unit is a component through which a part of the user's body or another object is used as a pointing object to input user commands. The touch unit may include, but is not limited to, a pressure-sensitive or electrostatic sensor such as a capacitive overlay or a resistive overlay type. The touch unit may be implemented as any type of sensor device capable of detecting contact of an object in addition to the sensors described above. The touch sensor may detect a user's touch input, generate a detection signal, and transmit the detection signal to the processor. The detection signal detected by the touch sensor may include coordinate data of the location at which the user input the touch.

The other input units include, for example, buttons, keyboards, dials, switches, sticks, and keys. In one embodiment of the present disclosure, the AR system 20 may further include a physical button in addition to the touch sensor 132. The physical button may be, for example, a button that receives a user input for switching a driving mode, such as turning on/off the autonomous driving mode or turning on/off the manual driving mode.

In FIG. 3, an upper display within a block 140 is a touch panel that integrates both output and input functions and includes the output unit 141 and the input unit 142. A lower display within the block 140 corresponds to the output unit 141 and lower buttons within the block 140 correspond to the input unit 142. Although the input device 142 and the output device 141 are shown separately in FIG. 3, in many embodiments the input device 142 and the output device 141 may be implemented as a single component to perform input reception and information output. For example, the input device 142 and the output device 141 may be a touch panel implemented as a touch screen forming a layered structure with a screen. Touch input is provided by a pointing object (including, for example, a part of the user's body or a tool).

Although the first display unit 130 and the second display unit 140 are illustrated in the present disclosure as separate devices, it will be apparent to those skilled in the art that in alternative embodiments, the first display unit 130 and the second display unit 140 may be implemented as a single device.

Referring back to FIG. 2, the GPS module 151 may communicate with GPS satellites to obtain GPS location information indicating the GPS coordinates of the module 151. Since the module 151 is installed in the agricultural vehicle, the GPS location information is treated as indicating the position of the agricultural vehicle. The GPS module 151 may transmit the GPS location information of the agricultural vehicle to the navigation system 110 for use in generating driving-related information such as the real-time position, real-time driving speed, and driving time of the agricultural vehicle.

The camera module 152 may capture a driving environment image representing the environment in which the agricultural vehicle is traveling, and generate driving environment image data. The driving environment image may be an image of objects located in front of, behind, or around the agricultural vehicle. The objects may include a user or other persons, agricultural land on which agricultural work is to be performed, crops subject to agricultural work, obstacles located on the route, and the like.

The camera module 152 may be various imaging elements that recognize light to generate images.

The driving environment image may be a captured image or a video image composed of consecutive driving environment images. The camera module 152 may transmit real-time driving environment images to the navigation system 110. For example, the camera module 152 may transmit a real-time driving environment video to the navigation system 110.

The AR system 20 may include one or more camera modules 152. In various embodiments of the present disclosure, the AR system 20 may include at least one camera module 152a capable of capturing the front of the agricultural vehicle, and at least one camera module 152b capable of capturing the rear of the agricultural vehicle. The driving environment image captured by the camera module 152a is a front view image representing the driving environment ahead, and the driving environment image captured by the camera module 152b is a rear view image representing the driving environment behind.

The steering angle sensor 153 is a sensor that detects the steering angle of the steering wheel. The steering angle sensor 153 may be a current sensor that measures the rotation angle in response to electrical characteristics that change as the steering wheel rotates, or an angle sensor that measures the degree of rotation of the steering wheel, but is not limited thereto.

The autonomous driving sensor 154 may be a sensor used to recognize objects located around the agricultural vehicle. The autonomous driving sensor 154 may be, for example, a radar, a lidar, an ultrasonic sensor, or other sensors.

The driving sensor 155 is a sensor that measures the real-time driving speed of the vehicle. The driving speed of the vehicle measured by the driving sensor 155 may be displayed on the instrument panel of the agricultural vehicle.

In addition, the agricultural vehicle 20 and the remote user terminal 100 (shown in FIG. 1) may receive, via wireless communication with the AR system 20, the GPS coordinates of the agricultural vehicle acquired through the GPS module 151 installed in the agricultural vehicle.

The communication unit 160 includes a wireless communication unit and may perform wireless data transmission and reception functions of the AR system 20. The wireless communication unit may establish wireless communication with the agricultural vehicle and/or the network computing device 30.

The wireless communication unit 160 may include, for example, a cellular communication module, a short-range wireless communication module, or a global navigation satellite system (GNSS) communication module. The wireless communication unit 160 may establish a communication connection with the agricultural vehicle or the network computing device 30 via a short-range communication network such as Bluetooth, wireless fidelity (WiFi) direct, or infrared data association (IrDA), or via a long-range communication network such as a legacy cellular network, a 5G network, a next-generation communication network, the Internet, or a computer network (e.g., LAN or WAN).

As shown in FIG. 1, the system 10 for providing an AR navigation screen for an agricultural vehicle according to various embodiments of the present disclosure may provide, to the AR system 20, a graphic user interface (GUI) for accurately displaying and calibrating the position of the agricultural vehicle on a map image.

In the AR system 20 according to various embodiments of the present disclosure, an application (hereinafter referred to as the application) may be executed for outputting an AR navigation screen including navigation information including a driving guidance route set for the work of the agricultural vehicle, driving-related information acquired while the agricultural vehicle travels along the driving guidance route, and driving error information indicating the gap between the actual position of the agricultural vehicle and the GPS location, and for outputting a graphic user interface (GUI) for accurately displaying and calibrating the position of the agricultural vehicle on a map image. The application may be configured to perform the method for providing an augmented reality navigation screen for an agricultural vehicle as described with reference to FIG. 4 and the like below.

In various embodiments, the application may be provided as part of at least one computer program product. A computer program product may be traded between a seller and a buyer as a commodity. The computer program product may be distributed in the form of a machine-readable storage medium (e.g., compact disc read only memory (CD-ROM)), or may be distributed online (e.g., downloaded or uploaded) via an application store (e.g., Play Store™ or App Store™) or directly between two user devices (e.g., smartphones). In the case of online distribution, at least a portion of the computer program product may be at least temporarily stored or transiently generated in a machine-readable storage medium such as a manufacturer's server, an application store's server, or a relay server's memory.

A method for providing an augmented reality navigation screen for an agricultural vehicle according to another aspect of the present disclosure may be performed by the AR system 20 of FIG. 2.

FIG. 4 depicts an illustrative embodiment of a method for providing an augmented reality navigation screen for an agricultural vehicle according to various aspect of the present disclosure described herein. Referring to FIG. 4, the method for providing an AR navigation screen for the agricultural vehicle includes: obtaining GPS location information describing the GPS location of the agricultural vehicle (step S100); obtaining navigation information set by an external device or set according to a user input to the AR system (step S200); and obtaining a driving environment image capturing the driving environment in which the agricultural vehicle is traveling (step S300). In addition, the method for providing the AR navigation screen may further include, prior to step S500, obtaining a user input for a driving mode indicating whether autonomous driving mode is on or off.

In step S100, the navigation system 110 may obtain GPS location information of the target agricultural vehicle in which the AR system 20 is installed from the GPS module 151. The GPS location information represents the position of the agricultural vehicle as recognized by GPS satellites, and may differ from the actual position of the agricultural vehicle depending on GPS performance.

The GPS location information may include time information indicating when the GPS coordinates of the agricultural vehicle were detected. The obtained GPS location information may be stored in the memory 120 (step S100).

In step S200, the navigation information includes driving guidance route information describing a driving guidance route along which the agricultural vehicle is to travel. In addition, the navigation information may further include one or more of: a map image of the driving guidance route representing the geographical area in which the driving guidance route is located, map information for the map image, and a driving guidance message for the driving guidance route. The map image may visually represent the geographical area surrounding the GPS coordinates of the agricultural vehicle. The map information describes the map elements shown in the map image. The map elements describe the driving environment of the agricultural vehicle and may include, for example, real property such as buildings, land, and roads, and their size, location, name, slope, and ground/building type, as well as geographical features such as mountains and rivers, and their elevation, size, location, name, slope, and type. In addition, the map elements may further include information describing objects located on real property or geographical features such as crops and trees.

The driving guidance route information indicates the position of the driving start point, the position of the driving destination, and the position of the route connecting them. The driving guidance route includes the driving route already traveled and the driving guidance route scheduled to be traveled in the future.

In step S200, the navigation system 110 may obtain, as the navigation information for generating the AR navigation screen, any one of: external navigation information set by a third-party system providing an external navigation service, internal navigation information set through a built-in navigation application based on a user input to the AR system 20, and a combination thereof. For example, the navigation information may be obtained by acquiring a map image and map information through the network computing device 30, and acquiring planned driving route information through a built-in navigation application.

In step S300, the navigation system 110 may obtain a driving environment image of the agricultural vehicle through the camera module 152. The driving environment image may be a real-time video image capturing the surrounding environment of the agricultural vehicle in real time.

The navigation system 110 may obtain a front surrounding environment image of the agricultural vehicle from the camera module 152a, and a rear surrounding environment image of the agricultural vehicle from the camera module 152b.

In addition, the method includes calculating driving-related information of the agricultural machine based on the GPS location information of the agricultural machine (step S500). In addition, in some embodiments, when the AR system 20 further includes the steering angle sensor 153 and/or the driving sensor 155, the method may further include obtaining steering angle information and/or real-time driving speed information prior to step S500 (step S400).

When the AR system 20 further includes the steering angle sensor 153 and/or the driving sensor 155, the navigation system 110 may obtain steering angle information received from the steering angle sensor 153 and/or driving speed information received from the driving sensor 155 (step S400). This information represents the real-time steering angle and real-time driving speed at the time of measurement. The navigation system 110 may generate driving-related information to be displayed on the AR navigation screen using the steering angle information and/or driving speed information (step S500).

The navigation system 110 may collect the GPS location information of the agricultural vehicle obtained in step S100 while the agricultural vehicle is traveling. For example, the navigation system 110 may collect GPS location information obtained from the start point of the driving guidance route to the current position at the time of generating the AR navigation screen.

The navigation system 110 may calculate the driving-related information of the agricultural vehicle based on the GPS location information of the agricultural machine obtained while the agricultural machine is traveling, or based on the GPS location information and the steering angle information of the agricultural machine obtained while the agricultural machine is traveling (step S500).

In various embodiments of the present disclosure, the driving-related information may include one or more of: driving mode information, a driving route, a driving distance according to the driving route, a driving time, a real-time driving speed of the agricultural vehicle at the real-time position of the agricultural vehicle, a driving azimuth angle, and a work coverage area.

The driving mode information represents a user input for the driving mode. The user input indicates the on/off state of the autonomous driving mode and the setting range of the autonomous driving speed limit (e.g., the maximum speed limit).

The driving route is a route tracked as a result of the agricultural vehicle actually traveling along the driving guidance route. The navigation system 110 may calculate the driving route by tracking changes over time in the GPS location of the agricultural machine obtained while the agricultural machine is traveling. The driving route may be the result of traveling for a single agricultural work session.

The driving distance and driving time for the driving route are the distance traveled and time elapsed from the driving start point to the current position at the time of generating the AR navigation screen. The navigation system 110 may calculate the driving distance and driving time based on the calculated driving route, the driving start time, and the current time at the time of generating the AR navigation screen.

The driving azimuth angle represents the angle of rotation of the vehicle based on a plan view of the vehicle. The driving azimuth angle may be expressed in a range of 360° (e.g., 0° to 180° and -180° to 0°). The navigation system 110 may calculate the driving azimuth angle based on changes in the GPS location information or the steering angle information.

The work coverage area is an area representing the result of work performed by the agricultural vehicle as it travels along the driving route. The work coverage area information may indicate the position and area of the region. The navigation system 110 may identify the work coverage area by applying the calculated driving route to a pre-stored unit work area per unit distance. The work coverage area may then be defined by accumulating the specifications of the unit work area based on the position of the driving route. The area of the work coverage area is the area corresponding to the identified work coverage area and may be referred to as the driving area. In one example, the specification of the unit work area may be a value matched to the width of the agricultural vehicle. In this case, the driving area of the agricultural vehicle may be the work coverage area of the agricultural vehicle.

In addition, the method includes obtaining a difference between the driving guidance route (or position) and the actual driving route (or position) of the agricultural machine as driving error information of the agricultural machine (step S600).

The driving error information may be referred to as OTE (Offset Error). In agricultural work, OTE is a term primarily used with GPS or position tracking systems to indicate the difference between an expected route or position and an actual route or position. It is used as a value indicating how far the actually traveled route deviates from the expected route. The driving error information indicates the position of the driving error, and the gap distance or area of the driving error.

The navigation system 110 may calculate the difference between the driving guidance route and the actual driving route of the agricultural vehicle by user input or through an error calculation program.

The navigation system 110 may obtain the difference between a position on the driving guidance route and a position on the actual driving route of the agricultural vehicle (step S600). The position on each route is a position at the same point in time. If the accuracy of the GPS location information is not 100%, the difference between them will not be zero, even if it is very small. An error of at least several centimeters to as much as several meters may occur between the position of the agricultural vehicle 20 indicated by the GPS coordinates and the actual position of the agricultural vehicle 20.

The difference between the driving guidance route and the actual driving route of the agricultural vehicle may be calculated by individually calculating the gap between different points in a geometric relationship, or by calculating the gap between the driving guidance route and the actual driving route of the agricultural vehicle. The navigation system 110 may calculate the difference between the driving guidance route and the actual driving route of the agricultural vehicle, and obtain the result as driving error information of the agricultural vehicle (step S600).

In addition, the method includes generating at least one AR graphic object visually representing at least one of the navigation information, the driving-related information of the agricultural machine, and the driving error information, and generating an AR navigation screen in which the AR graphic object is presented on the driving environment image (step S700).

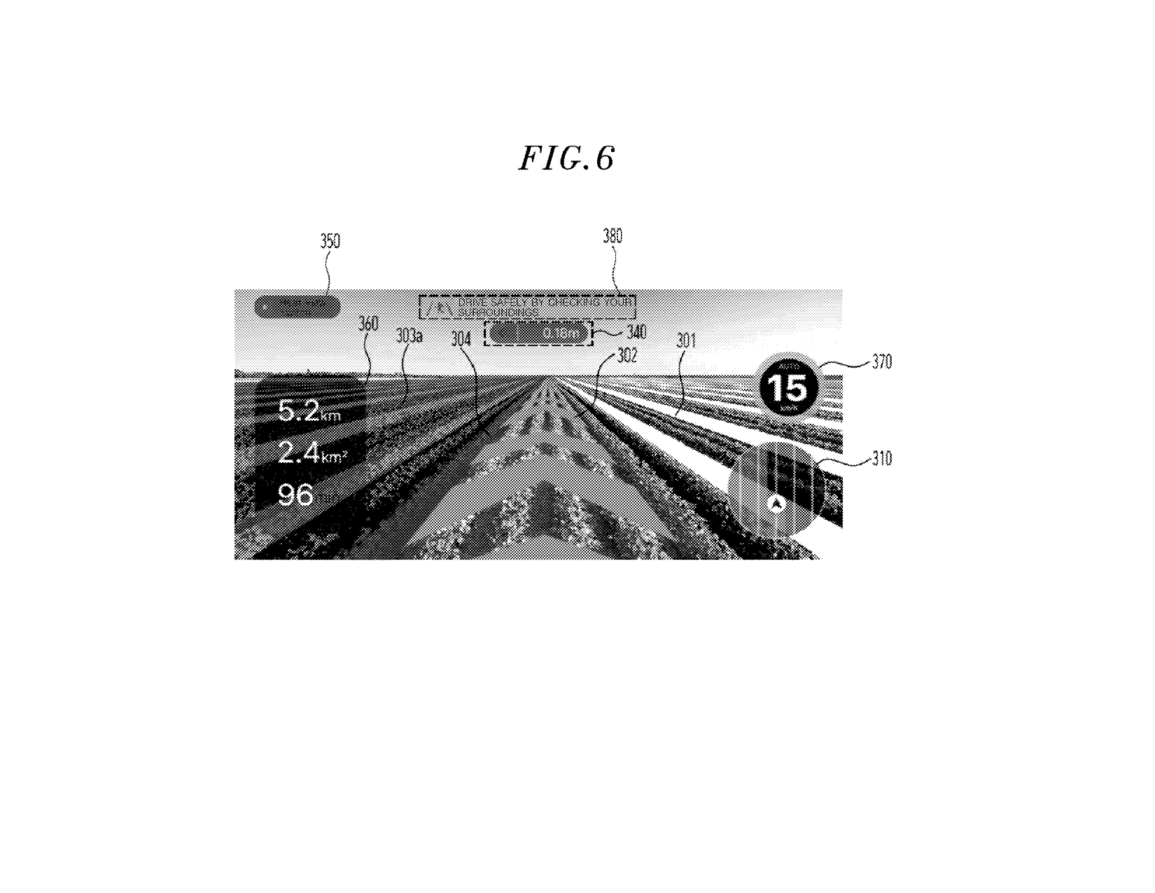

FIG. 5 depicts an illustrative embodiment of another method for generating an AR navigation screen in which the AR graphic object is presented on the driving environment image, according to various embodiments of the present disclosure described herein. FIG. 6 illustrates an exemplary, non-limiting embodiment of an AR navigation screen according to various embodiments of the present disclosure described herein.

The AR navigation screen may include a plurality of AR graphic objects. An AR graphic object is a virtual three-dimensional component that is added to the actual environment to provide the user with visual information or experience.

Referring to FIG. 5, step S700 of generating the AR navigation screen includes: identifying a location of a graphic object representing at least one of the navigation information and the driving-related information on the driving environment image (step S710); generating a shape of each graphic object based on the identified location (step S720); and overlaying the shape of the graphic object to which an identified color has been applied onto the identified location on the driving environment image to generate the AR navigation screen in which the shape of the graphic object is represented on the driving environment image (step S740). In addition, in some embodiments, step S700 may further include, prior to step S740, applying a pre-set color and/or transparency for the information represented by the graphic object to the shape of the graphic object (step S730).

In various embodiments of the present disclosure, the AR graphic object includes a first graphic object 301 that visually represents the driving guidance route. In addition, the AR graphic object may further include one or more of: a second graphic object 302 that visually represents the work coverage area according to the driving of the agricultural vehicle, a third graphic object 303 that visually represents the driving direction, and a fourth graphic object 304 that visually represents the driving error information.

In step S710, the navigation system 110 may identify the location on the 2D coordinate system of the driving environment image at which each AR graphic object 301 through 304 is to be placed.

In various embodiments of the present disclosure, the step of identifying the location of the AR graphic object on the driving environment image (step S710) may include: identifying the location of the first graphic object 301 based on the GPS location information of the agricultural vehicle, map information of a geographical area including the GPS location of the agricultural vehicle, driving heading information of the agricultural vehicle, and parameters of the camera module; when the AR graphic object includes the second graphic object 302, identifying the location of the second graphic object 302 based on the identified location of the first graphic object 301, driving route information, driving distance information, and pre-stored unit work coverage area information per unit driving distance; when the AR graphic object includes the third graphic object 303, identifying the location of the third graphic object 303 based on the identified location of the first graphic object 301 and the driving heading information; and when the AR graphic object includes the fourth graphic object 304, identifying the location of the fourth graphic object 304 based on the identified location of the first graphic object 301 and the driving error information.

To identify the location of the AR graphic object, the navigation system 110 may calibrate the intrinsic and extrinsic parameters of the camera to define the relationship among the 2D driving environment image, the GPS location, and the AR graphic object.

The navigation system 110 may identify the location of the first graphic object 301 at which the first graphic object 301 is to be placed on the driving environment image, based on the current GPS location information of the agricultural vehicle at the time of generating the AR navigation screen, map information of the map image including the coordinates at which the agricultural vehicle is located, current driving heading information of the agricultural vehicle at the time of generating the AR navigation screen, and parameters of the camera module.

In various embodiments of the present disclosure, the step of identifying the location of the first graphic object 301 may include: mapping a 2D coordinate system for the driving environment image and a 3D coordinate system for a virtual 3D world; calculating a 3D location of the driving guidance route in the virtual 3D world based on the map information and the driving guidance route information; and changing the 3D location of the driving guidance route to a 2D location of the driving guidance route through a mapping relationship between the 2D coordinate system and the 3D coordinate system, and identifying the changed 2D location of the driving guidance route as the location of the first graphic object.

The 2D coordinate system is the 2D coordinate system of the driving environment image. The virtual 3D world is a three-dimensional virtual space for the geographical area shown in the map image. The navigation system 110 maps the 2D coordinate system of the driving environment image and a 3D coordinate system in the virtual 3D world to define a positional relationship between the 2D coordinate system and the virtual 3D world (hereinafter, coordinate mapping relationship). The navigation system 110 may then use the defined coordinate mapping relationship to convert virtual 3D coordinates into 2D coordinates in the driving environment image.

In some embodiments, the step of mapping the 2D coordinate system for the driving environment image and the 3D coordinate system for the virtual 3D world may include: setting intrinsic parameters of the camera module 152 to map 2D coordinates of the driving environment image and virtual 3D world coordinates. In addition, in some embodiments, the step of mapping the 2D coordinate system for the driving environment image and the 3D coordinate system for the virtual 3D world may further include: setting extrinsic parameters of the camera module 152 with respect to the virtual 3D world in which coordinates are mapped, by analyzing the relationship between an object in the 3D world and a 2D representation of the object on the driving environment image in which the object was captured.

The navigation system 110 may perform an operation of optimizing the intrinsic parameters of the camera module 152 to map the 2D coordinates of the driving environment image and the virtual 3D world coordinates. The intrinsic parameters of the camera module 152 include one or more of a principal point, a focal length, and distortion coefficients. The principal point is the point at which the lens centerline passes through the sensor on the image sensor, and in most cases is located close to the center of the image. The focal length is the distance between the lens and the image sensor. The focal lengths for the x-axis and y-axis may differ. The distortion coefficient is a coefficient for correcting image distortion caused by lens distortion, and may primarily be expressed as coefficients for radial distortion and tangential distortion.

The extrinsic parameters of the camera module 152 may further include one or more of rotation and translation. The rotation parameter indicates the direction of rotation of the camera and may be expressed as a 3×3 rotation matrix. The translation parameter may be expressed as a translation vector from the world coordinate system to the camera coordinate system.

To analyze the relationship between an object in the 3D world and a 2D representation of the object on the driving environment image in which the object was captured, the navigation system 110 may analyze the relationship between features of an object in the 3D world and a 2D representation of the features of the object as shown on the driving environment image in which the object was captured. The navigation system 110 may extract the 2D representation through an image processing algorithm that extracts 2D representations, and analyze the 2D representation of the object and the 3D features of the corresponding object. The features may be geometric features such as edges and corners.

The object in the 3D world is an object used as a map element and may be, for example, a building, a geographical feature (e.g., a mountain), or crops.

The driving environment image providing the 2D representation may be a series of driving environment images captured during rotation or movement of the camera module 152 (e.g., rotation video, movement video).

In some embodiments, the navigation system 110 may map the 3D coordinate system and the 2D coordinate system using the GPS location of the agricultural vehicle. For example, the object providing the 2D representation may be an object located near the GPS location of the agricultural vehicle.

In some embodiments, step S710 may further include recognizing objects located around the agricultural vehicle by analyzing objects shown in the driving environment image.

The navigation system 110 may, in order to map the 2D coordinate system and the 3D coordinate system, obtain a positional relationship between the location of an object recognized in the 2D driving environment image and the 3D location of the object, and calculate a coordinate mapping relationship by mapping the 2D coordinates of the driving environment image and the virtual 3D world coordinates based on the positional relationship and the result of setting the intrinsic parameters.

The navigation system 110 may recognize objects using various object recognition models. The object recognition model may be a vision recognition model that extracts features from an input image, processes them computationally, and infers correlations between the object and the extracted features based on the computational results to recognize the object in the input image. The object recognition model may have a CNN architecture, but is not limited thereto. For example, the object recognition model may be an open-source vision recognition model such as OpenCV.

The navigation system 110 may identify the locations of the remaining graphic objects 302 through 304 based on the location of the first graphic object 301 identified in the 2D coordinate system of the driving environment image (step S710).

The location of the work coverage area corresponding to the second graphic object 302 may be the location of points and/or lines defining the work coverage area. In some embodiments, the location of the second graphic object 302 may be expressed as the location of the driving route and the unit work coverage area per unit driving distance (e.g., unit work width). To identify the location of the second graphic object 302, the navigation system 110 may calculate the 3D location of the work coverage area based on work coverage area information of the agricultural vehicle pre-calculated through the identified location of the first graphic object, driving route information, driving distance information, and the pre-stored unit per unit driving distance, change the 3D location of the work coverage area to a 2D location on the 2D coordinate system of the driving environment image of step S300 through the coordinate mapping relationship, and identify the changed 2D location of the work coverage area as the location of the second graphic object. The 3D location is a location in the virtual 3D world.

The location of the current driving direction corresponding to the third graphic object 303 may be the location of a virtual line extending from the current position of the agricultural vehicle by the driving azimuth angle. To identify the location of the third graphic object 303, the navigation system 110 may calculate the 3D location of a virtual line representing the current driving direction at the time of generating the AR navigation screen based on the identified location of the first graphic object 301 and the driving heading information, change the 3D location of the current driving direction to a 2D location on the 2D coordinate system of the driving environment image of step S300 through the coordinate mapping relationship, and identify the changed 2D location of the current driving direction as the location of the third graphic object S303.

The location of the driving error corresponding to the fourth graphic object 304 may be the location of a gap indicating the driving error. When the gap extends along the driving route, the driving error may form a driving error area having a continuously integrated area. In that case, the location of the driving error corresponding to the fourth graphic object 304 is the location of the driving error area, which may be the location of points and/or lines defining the driving error area. To identify the location of the fourth graphic object 304 based on the identified location of the first graphic object 301 and the driving error information, the navigation system 110 may calculate the 3D location of the driving error based on the identified location of the first graphic object 301 and the driving error information, change the 3D location of the driving error to a 2D location on the 2D coordinate system of the driving environment image of step S300 through the coordinate mapping relationship, and identify the changed 2D location of the driving error as the location of the fourth graphic object 304.

In step S720, the navigation system 110 may apply pre-configured shape configuration information for each AR graphic object 301 through 304 to the identified location on the 2D coordinate system of the driving environment image, and generate the shape of each AR graphic object 301 through 304. The shape of the AR graphic object is the shape represented in the driving environment image.

In some embodiments, the shape configuration information for the first graphic object 301 may represent a line shape extending along the location of the driving guidance route. The navigation system 110 may apply the shape configuration information for the first graphic object 301 to the identified location of the first graphic object 301 to generate a line shape extending along the identified location as the shape of the first graphic object 301 to be displayed on the 2D driving environment image.

The shape configuration information for the second graphic object 302 may represent an area shape covering the work coverage area. The navigation system 110 may apply the shape configuration information for the second graphic object 302 to the identified location of the second graphic object 302 to generate an area shape covering the identified location as the shape of the second graphic object 302 to be displayed on the 2D driving environment image.

The shape configuration information for the third graphic object 303 may represent at least one arrow shape that continues along the driving direction. The navigation system 110 may apply the shape configuration information for the third graphic object 303 to the identified location of the third graphic object 301 to generate a series of arrow shapes along the identified location as the shape of the third graphic object 303 to be displayed on the 2D driving environment image.

The shape configuration information for the fourth graphic object 304 may represent a line shape when the driving error information is a driving error gap, or an area shape when the driving error information is a driving error area. For example, the navigation system 110 may apply the shape configuration information for the fourth graphic object 304 to the identified location of the fourth graphic object 304 to generate an area shape covering the identified location as the shape of the fourth graphic object 304 to be displayed on the 2D driving environment image.

In step S730, the navigation system 110 may apply pre-set color and/or transparency configuration information for each AR graphic object to the shape of the AR graphic object. For example, as shown in FIG. 6, the color configuration information for the driving guidance route may be white, and the color configuration information for the driving direction may be green, but is not limited thereto.

In some embodiments, the color configuration information for the work coverage area may include color configuration information according to the driving mode. Specifically, the color configuration information for the work coverage area may include first color configuration information for the work coverage area determined by driving in manual driving mode (i.e., autonomous driving mode off state), and second color configuration information for the work coverage area determined by driving in autonomous driving mode (i.e., autonomous driving mode on state). For example, as shown in FIG. 6, the first color configuration information may be orange, and the second color configuration information may be green. When such color configuration information is applied, as shown in FIG. 6, the work coverage area worked in manual driving mode (i.e., non-autonomous driving mode) among the entire work coverage area of the agricultural vehicle is implemented as a second graphic object 303a to which the first color is applied, and the work coverage area worked in autonomous driving mode is implemented as a second graphic object 303b to which the second color is applied, and may be displayed on the AR navigation screen.

The navigation system 110 applies a pre-set transparency for each piece of information indicated by the object. The transparency is set to either a maximum value representing complete transparency or a minimum value representing complete opacity. The transparency of at least one graphic object may be set to a partially transparent value.

In some embodiments, the transparency of the second graphic object 302 and the third graphic object 303 may be set to be more transparent than the transparency of the first graphic object 302 and the fourth graphic object 304.

When the AR graphic objects 301 through 304 to which the pre-set colors have been applied to the generated shapes are overlaid, an AR navigation screen can be generated that provides the user with driving error information, driving direction information, work coverage area information, and driving guidance route information through visual elements such as the color, location, and shape of the AR graphic objects 301 through 304, as shown in FIG. 6 (step S740).

In addition, in some embodiments, step S700 of generating the AR navigation screen may further include: generating a map view area 310 indicating the recognized position of the agricultural machine based on the GPS location information of the agricultural machine, a map image including the geographical area around the agricultural machine, driving heading information of the agricultural machine at the recognized position, work coverage area information, and a surrounding area of the agricultural machine (step S760); and/or generating an error view area 320 describing the current driving error of the agricultural machine at the time of generating the AR navigation screen based on the driving error information (step S770). In addition, step S700 may further include additionally overlaying one or more of the map view area 310 and the error view area 340 onto the driving environment image of step S300 to generate the AR navigation screen in which one or more of the map view area and the error view area are additionally displayed (step S780).

The map view area 310 and the error view area 320 are composed of a plurality of display components displayed in the respective areas. The display components may be 2D graphic objects that visually represent the corresponding information on a 2D plane.

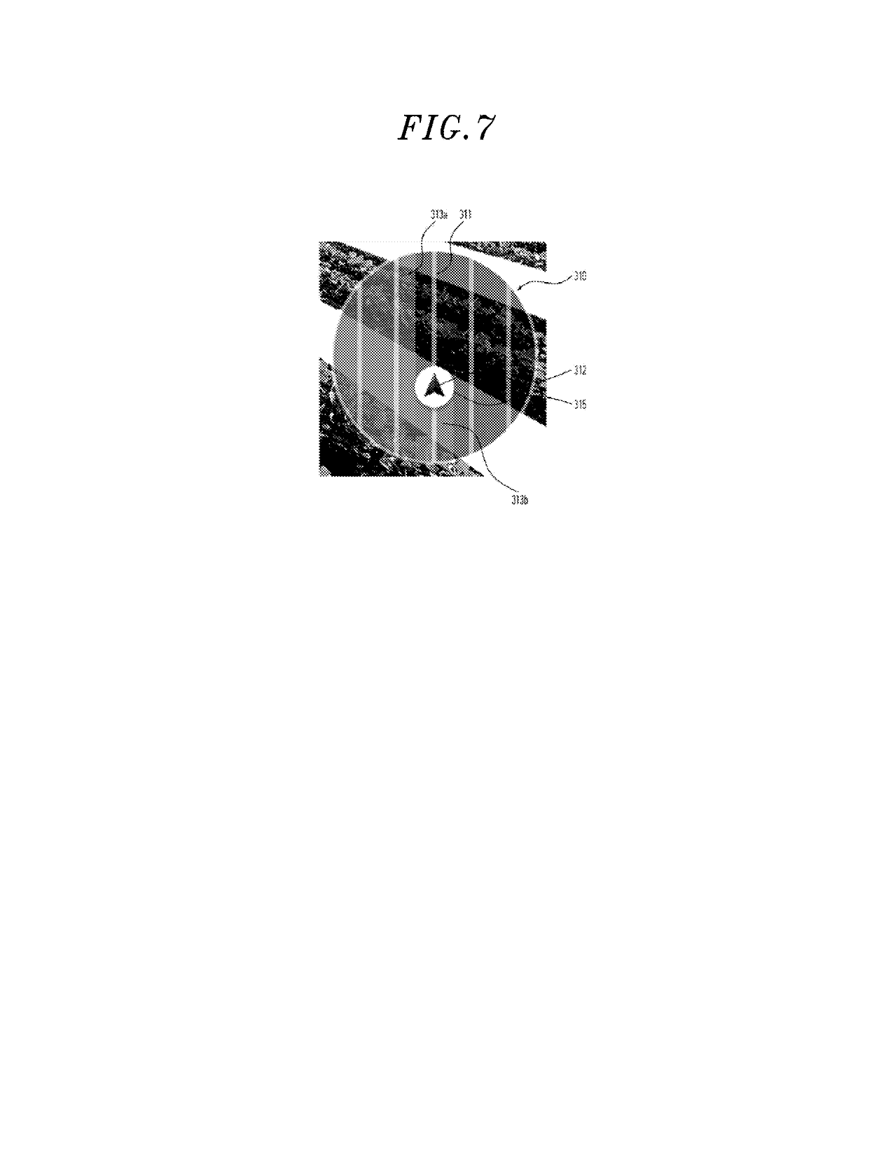

FIG. 7 illustrates an exemplary, non-limiting embodiment of components of a map view area according to various embodiments of the present disclosure described herein. Referring to FIG. 7, the map view area 310 may include a driving vehicle object 315 indicating the recognized position of the agricultural vehicle, a driving guidance route object 311 indicating the driving guidance route, a driving direction object 312 indicating the driving direction of the agricultural vehicle, and a work coverage area object 313 indicating the work coverage area of the agricultural vehicle.

The driving vehicle object 315 may have a vehicle shape preset to correspond to the agricultural vehicle. The driving vehicle object 315 displays the position of the agricultural vehicle on the map of the navigation screen. The driving object shape may be a realistic shape such as a plan view of the agricultural vehicle, or may be a simpler shape such as a circle as shown in FIG. 7. The driving vehicle object 315 of a simpler shape is not limited to a circle and may be a triangle, rectangle, oval, or the like.

The position of the agricultural vehicle indicated by the driving vehicle object 315 is the recognized position of the agricultural machine as recognized by the AR system 20. The navigation system 110 primarily recognizes the position of the agricultural machine based on the GPS coordinates indicated in the GPS location information of the agricultural machine (step S760). In addition, when the actual position and the GPS location of the agricultural vehicle are matched and the driving error is removed by the calibration operation described below, the recognized position of the agricultural machine indicated by the driving vehicle object 315 reflects the calibration relationship applied to the GPS coordinates and represents the corrected actual position.

The driving direction object 312 represents the measured driving direction at the time of display. The driving direction object 312 may be, for example, an arrow shape as shown in FIG. 7, but is not limited thereto; the arrow may be represented only as a line or as a combination of a line and an area shape. In various embodiments, the driving direction object 312 may be included within the shape of the driving vehicle object 315.

Referring again to FIG. 6, the error view area 340 may indicate the relative position of the driving error with respect to the agricultural vehicle, the gap length of the driving error, or the area of the driving error region. In some embodiments, the navigation system 110 may calculate the relative position of the driving error with respect to the agricultural vehicle based on the GPS location information of the agricultural vehicle and the position of the driving error within the driving error information, and generate an error view area 340 expressing the gap length of the driving error and the relative position of the driving error with respect to the agricultural vehicle as shown in FIG. 6 (step S770).

In addition, in some embodiments, step S700 may further include a step of expressing at least one piece of information among the navigation information and the driving-related information on the AR navigation screen (step S790). The at least one piece of information may be expressed in the form of text, graphics, or a combination thereof.

Specifically, step S790 may include: displaying the driving distance information of the agricultural vehicle, the area of the work coverage area, and the driving time information within the calculated driving-related information in a first sub-area 360 of the navigation screen; displaying the driving mode information of the agricultural vehicle in a second sub-area 370 of the navigation screen; and/or displaying the contents of a driving guidance message within the obtained navigation information in a sub-area 380 of the navigation screen.

The navigation system 110 may be configured to express the driving distance information of the agricultural vehicle, the area of the work coverage area, and the driving time information within the driving-related information calculated in step S500 in text form in the sub-area 360 of the navigation screen.

In addition, the navigation system 110 may be configured to express the driving mode information of the agricultural vehicle in the sub-area 370 of the navigation screen in a combination of text form and graphic form. In one example, when the current driving mode of the agricultural vehicle at the time of generating the AR navigation screen is autonomous driving, the sub-area 370 may display text indicating the autonomous driving mode (AUTO), text indicating the setting range of the autonomous driving speed limit (e.g., the maximum speed limit) (15 km/h), and a border shape indicating the on state of the autonomous driving mode.

In addition, the navigation system 110 may be configured to express the contents of the driving guidance message within the navigation information obtained in step S200 in the sub-area 380 of the navigation screen. The graphic form expressing the contents of the driving guidance message may be implemented as a graphic object summarizing the contents of the driving guidance message.

The navigation system 110 may output, through the first display unit 130, an AR navigation screen including the graphic objects 301 through 304 overlaid in step S740, the information display areas 310 and 340 overlaid in step S780, and the information 360 through 380 expressed in step S790.

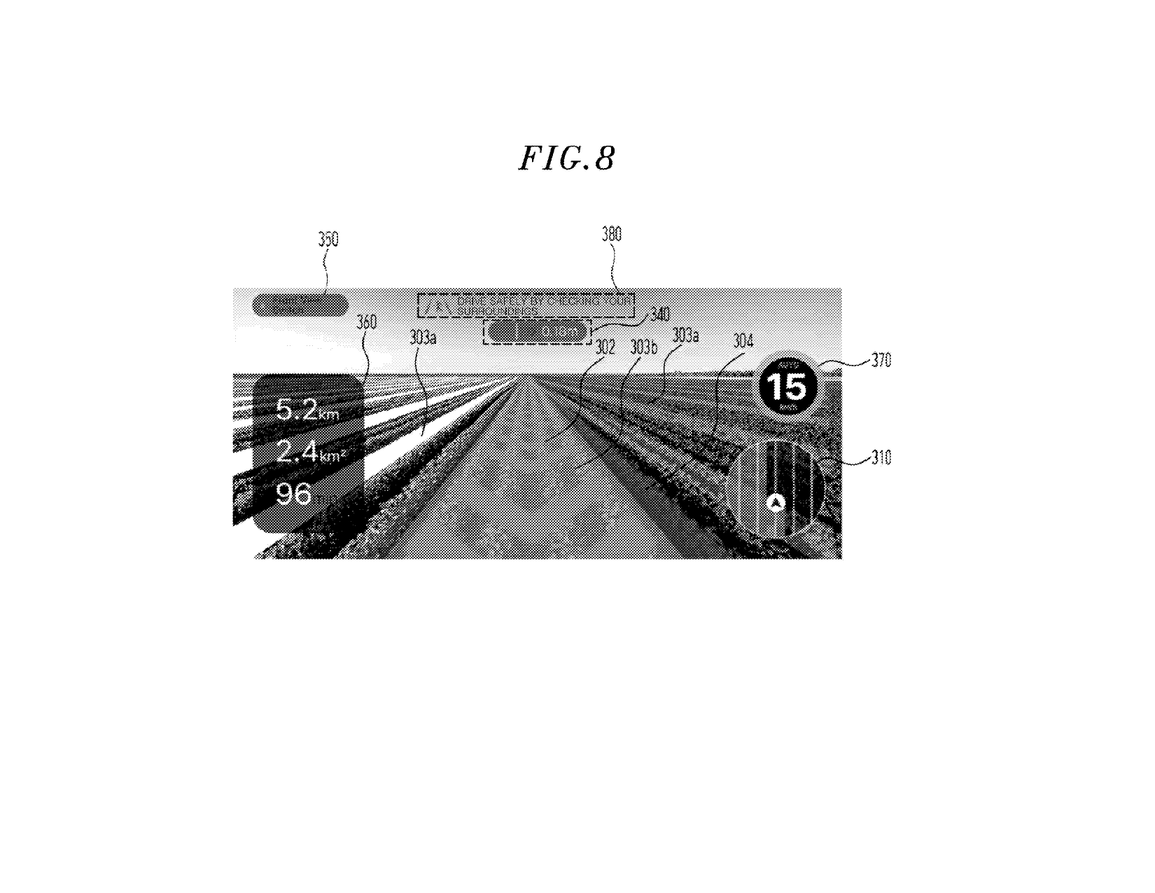

FIG. 8 illustrates an exemplary, non-limiting embodiment of an AR navigation screen displaying the rear of an agricultural vehicle, according to various embodiments of the present disclosure described herein. Referring to FIG. 8, the driving environment image overlaid in step S740 is the driving environment image in the shooting direction designated at the time of generating the AR navigation screen. When the user designates an AR navigation screen displaying the forward shooting direction, the graphic objects 301 through 304 are overlaid on the driving environment image representing the driving environment ahead, providing the AR navigation screen of FIG. 6. Alternatively, when the user designates an AR navigation screen displaying the rearward shooting direction, the graphic objects 301 through 304 are overlaid on the driving environment image representing the driving environment behind, providing the AR navigation screen of FIG. 8.

Since the AR navigation screen of FIG. 8 includes the same or similar screen components as the AR navigation screen of FIG. 6 (301 through 304, 310, 340 through 380), a detailed description thereof is omitted.

In various embodiments of the present disclosure, the AR navigation screen may be further configured to receive a user input for switching the shooting direction. When a user's touch input is received in a sub-area 350 indicating the shooting direction to be switched, the AR navigation screen may generate an AR navigation screen in which a driving environment image corresponding to the selected shooting direction is displayed, in response to a user input for selecting a different shooting direction.

When the user's touch is input to the sub-area 350, the navigation system 110 may perform at least some of the operations in steps S710 through S790 to generate an AR navigation screen for the shooting direction for which the user commanded a switch, and output it through the first display unit 130. Specifically, when the user's touch is input to the sub-area 350, the navigation system 110 may perform the operations of steps S710 through S740 in response to the touch on the sub-area 350. Here, the driving environment image of steps S740 and S780 is an image of the shooting direction selected by the switch (e.g., rear view).

For example, when the user touches the sub-area 350 on the AR navigation screen displaying the front of the agricultural vehicle shown in FIG. 6, the AR navigation screen displaying the rear of the agricultural vehicle shown in FIG. 8 may be generated and displayed on the first display unit 130. Conversely, when the user touches the sub-area 350 shown in FIG. 8, the AR navigation screen of the first display unit 130 may switch from the AR navigation screen of FIG. 8 to the AR navigation screen of FIG. 6.

The AR navigation screen generated in this manner displays the OTE in the error view area 340, and also displays it on the corresponding AR graphic object 304 in a unique identification color (e.g., red, but not limited thereto), thereby conveying the information clearly. Through this method, the user can check the accuracy of the driving route in real time. If a radar is installed together with the camera, the navigation system 110 may detect obstacles ahead and provide warning graphics and sound to enhance safety. The driving route clearly distinguishes between the driving guidance route (displayed in white) and the past driving route (green for autonomous driving / orange for manual driving) using colors, enabling accurate identification of driving history. Through this, in the case of a sprayer tractor loaded with herbicide, the areas where herbicide has been applied and the areas where herbicide is yet to be applied can be accurately distinguished using the AR navigation screen, making it possible to avoid overlapping and proceed with work at optimal efficiency without wasting herbicide. In addition to the real-time camera perspective view, a map view 310 is provided, allowing the user to grasp the position and route of the currently operating vehicle from a macro perspective. Since the driving route 311 and the previously traveled route 313a and 313b (shown in FIG. 7) are also displayed in the same manner in the map view 310, they can be cross-referenced with the real-time AR route for accurate position recognition. On the speedometer, when autonomous driving is activated, the circular graphic outline 360 is displayed in a unique color (e.g., green), and when switched to manual driving, it is displayed in orange. This enables the user to check the current driving status while minimizing eye movement without looking away at another screen.

Referring again to FIG. 4, in various embodiments of the present disclosure, S800 of the method shown in FIG. 4 may further include removing the driving error using the AB driving reference line .

When the agricultural vehicle 20 must perform autonomous driving along a precise route, such as a tractor planting seeds, even an error of 10 cm may not be permissible. The navigation system 110 may perform a calibration operation of matching the GPS coordinates of the agricultural vehicle with the actual position of the agricultural vehicle using the AB driving reference line (step S800). Specifically, the navigation system 110 may provide a GUI for AB driving reference line calibration on a display to remove driving error information (step S800).

The GUI screen for the AB driving reference line calibration may be displayed on a second display installed in the agricultural vehicle or on the user terminal 100 communicating with the agricultural vehicle.

By performing step S800, the fourth graphic object 304 displayed on the AR navigation screen of FIGS. 6 and 7 may be relatively reduced compared to before the operation of step S800. For example, by performing step S800, the fourth graphic object 304 displayed on the AR navigation screen of FIGS. 6 and 7 may be removed. In addition, by the operation of step S800, the gap length of the driving error displayed on the error view area 340 included in the AR navigation screen of FIGS. 6 and 7 may decrease compared to before performing step S800. For example, by performing step S800, the gap length of the driving error displayed in the error view area 340 of the AR navigation screen of FIGS. 6 and 7 may be changed to 0 m.

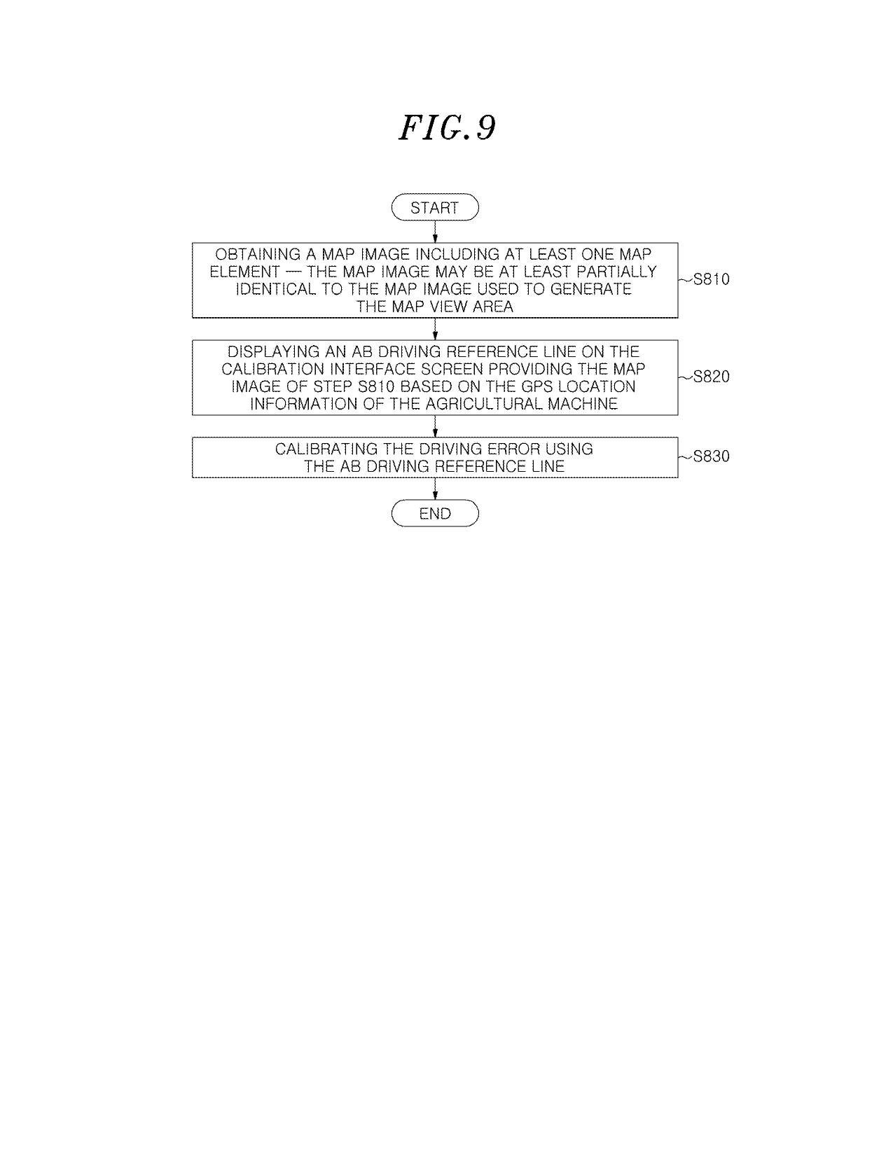

FIG. 9 depicts an illustrative embodiment of further another method for removing a driving error of the agricultural vehicle by providing a GUI for AB driving reference line calibration on a display, according to various embodiments of the present disclosure described herein. The method shown in FIG. 9 further implements the displaying step (S800) shown in FIG. 4.

For example, the method shown in FIG. 9 may be performed by executing a program on a computing device such as the processor of FIG. 2 to drive the AR system 20 or the agricultural vehicle of FIG. 1. The method of FIG. 9 may include one or more steps, operations, functions, or actions as illustrated by steps S810 through S830. Meanwhile, the steps illustrated in FIG. 9 are provided as examples only, and some of the steps may be optional, may be combined into fewer operations, or may be expanded into additional operations without departing from the spirit of the disclosed embodiments.

Referring to FIG. 9, step S800 may begin with step S810 in which the AR system 20 acquires a map image including at least one map element based on GPS coordinates. The AR system 20 may acquire a map including at least one map element from the network computing device 30.

In step S810, the map image may be displayed on a second display installed in the agricultural vehicle or on the user terminal 100 communicating with the agricultural vehicle. The map image displayed on the second display or the user terminal 100 may be a map image representing the same or a different geographical area as the map image displayed through the AR navigation screen on the first display device.

For example, in step S810, the map image may represent a wider geographical area than the map image displayed on the map view area 310.

In some embodiments, in step S810, the map may be an actual satellite map image captured by the satellite 40. By using a satellite map image captured by the satellite 40, the present disclosure enables the user to intuitively recognize the position of the agricultural vehicle without experiencing a sense of discrepancy between the actual position of the agricultural vehicle and the position displayed on the map image, as compared to the case of using a virtual map image or a simplified map image using computer graphics.

In one embodiment of the present disclosure, the satellite-captured image may be acquired from an external network computing device (e.g., Google Maps, Bing Maps, Apple Maps, or NASA Worldview). Such satellite-captured images may be built as a database by the network computing device 30, or may be directly acquired by the AR system 20 through a service provided by an external network computing device.

In step S810, the GPS coordinates may indicate the position of the agricultural vehicle currently recognized by the AR system 20. When GPS coordinates are acquired by the GPS module included in the agricultural vehicle, the AR system 20 may receive the corresponding GPS coordinates from the agricultural vehicle.

The navigation system 110 shown in FIG. 2 may acquire the map image of step S810 using the GPS location information obtained in step S100. The AR system 20 may transmit the GPS coordinates obtained in step S100 to the network computing device 30 to request a map image corresponding to the GPS coordinates (step S810).

In one embodiment of the present disclosure, in step S810, the AR system 20 may receive from the network computing device 30 all map images within a certain range based on GPS coordinates. Alternatively, in one embodiment, the AR system 20 may periodically or when the agricultural vehicle travels a certain distance, request and acquire a map image from the network computing device 30. Alternatively, in one embodiment, the AR system 20 may receive a map image from the network computing device 30 in real time.

In the present disclosure, map elements may refer to elements that help the user easily recognize the map image displayed on the AR system 20 and the position of the agricultural vehicle, such as contour lines and major place names.

In step S820, the AR system 20 may display the AB driving reference line on the calibration interface screen on the map image. The calibration interface screen is a GUI for performing the calibration operation of step S800, and may include images, text, objects, modals, and indicators displayed on the display 131 by an application (or computer program) executed on the AR system 20.

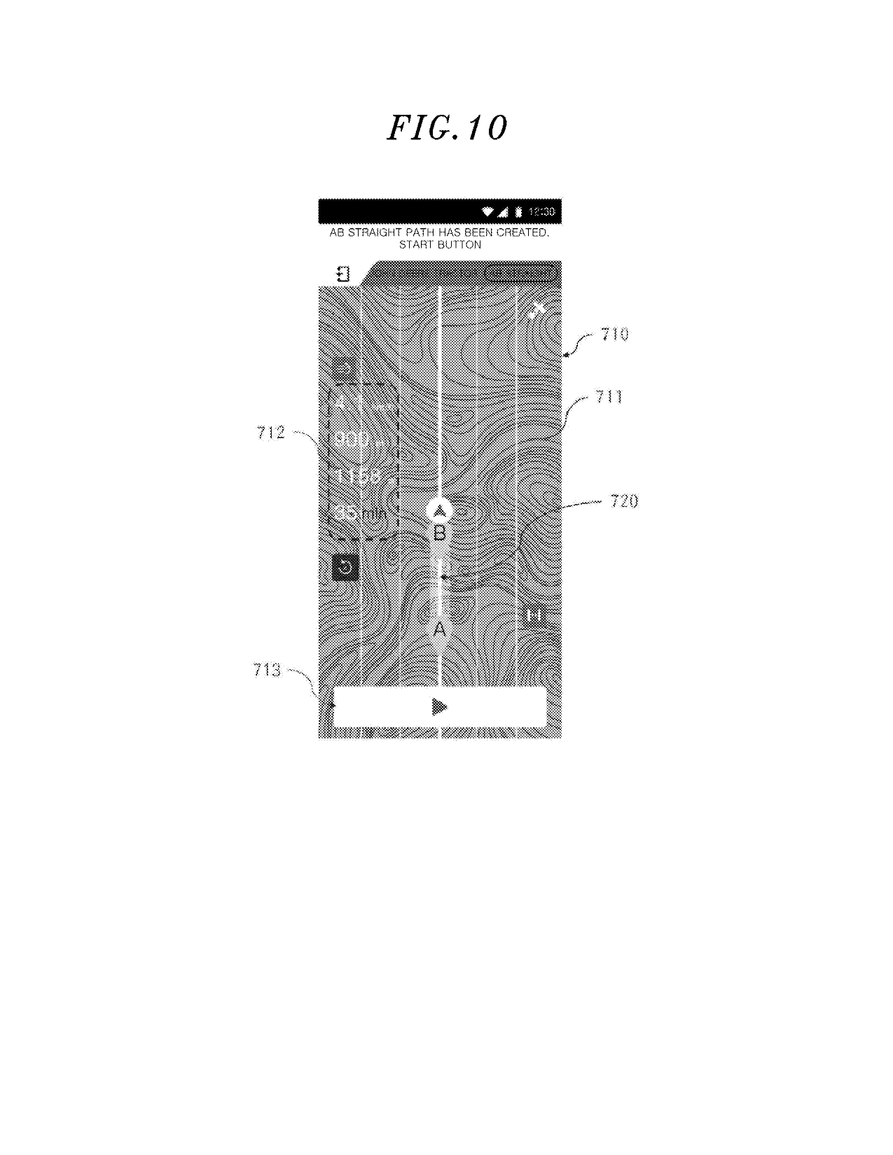

FIG. 10 illustrates an exemplary calibration interface screen according to various embodiments of the present disclosure. Referring to FIG. 10, the AR system 20 may display the map image 710 acquired in step S810 and an AB driving reference line 720 on the map image 710. For example, the screen illustrated in FIG. 10 may be displayed by an application executed on the AR system 20.

The map image 710 may correspond to GPS coordinates and may include contour lines 711 as at least one map element. In addition, the map image 710 may include status information 712 displaying the driving speed, distance, work area, and work time of the agricultural vehicle.

The AB driving reference line 720 may be displayed on the map image 710. The AB driving reference line 720 may refer to a route from point A to point B on the map image 710. The AB driving reference line 720 may be, for example, a straight line, but is not limited thereto. Depending on the shape of the route between point A and point B, the reference line 720 may have at least a partially curved section.

In the AB driving reference line 720, point A is the recognized position of the agricultural vehicle currently recognized by the AR system 20, as indicated by the GPS coordinates of the agricultural vehicle, and may be regarded as the current position on the map image 710.

In various embodiments of the present disclosure, the AB driving reference line 720 may be at least a partial route of the driving guidance route. For example, the AB driving reference line 720 may have, as point A, the current recognized position at the time of calibration on the driving guidance route of step S200, and as point B, any point on the route between point A and the destination of the driving guidance route. In some embodiments, point B may be any point on a straight section of the route between point A and the destination of the driving guidance route.

Referring back to FIG. 9, in step S830, the AR system 20 may calibrate the error of the AB driving reference line based on user input. In one embodiment, the user may calibrate by providing touch input to the left area 731 and the right area 732 with respect to the AB driving reference line 720 on the map image 710. The calibration may be correcting the position indicated by the GPS coordinates and the actual position of the agricultural vehicle. When calibrated in step S830, the map image 710 and the AB driving reference line 720 displayed on the map image 710 may be updated according to the corrected position. In addition, when calibrated in step S830, the display of the contour lines 711 as a map element displayed on the map image 710 may also be updated according to the corrected position.

The user may fix the steering wheel of the agricultural vehicle to drive straight along the AB driving reference line 720. When the user perceives that the actual driving route of the agricultural vehicle is to the left of the AB driving reference line 720, the user may touch the left area 731 of the AB driving reference line 720 on the map image 710 displayed on the AR system 20 to calibrate.

Alternatively, when the user perceives that the actual driving route of the agricultural vehicle is to the right of the AB driving reference line 720, the user may touch the right area 732 of the AB driving reference line 720 on the map image 710 displayed on the AR system 20 to calibrate.

An error of at least several centimeters to as much as several meters may occur between the position of the agricultural vehicle indicated by the GPS coordinates and the actual position of the agricultural vehicle. When the agricultural vehicle must perform autonomous driving along a precise route, such as a tractor planting seeds, even an error of 10 cm may not be permissible.

Even in such cases, the GUI provided by the system 10 for providing an AR navigation screen for an agricultural vehicle according to one embodiment of the present disclosure provides the user with the actual satellite-captured map image 710, displays the AB driving reference line 720 on the map image 710, and can provide a user experience (UX) that enables precise calibration through simple and intuitive touch input alone.

The following describes the specific calibration processes provided by the system 10 for providing an AR navigation screen for an agricultural vehicle according to various embodiments of the present disclosure.

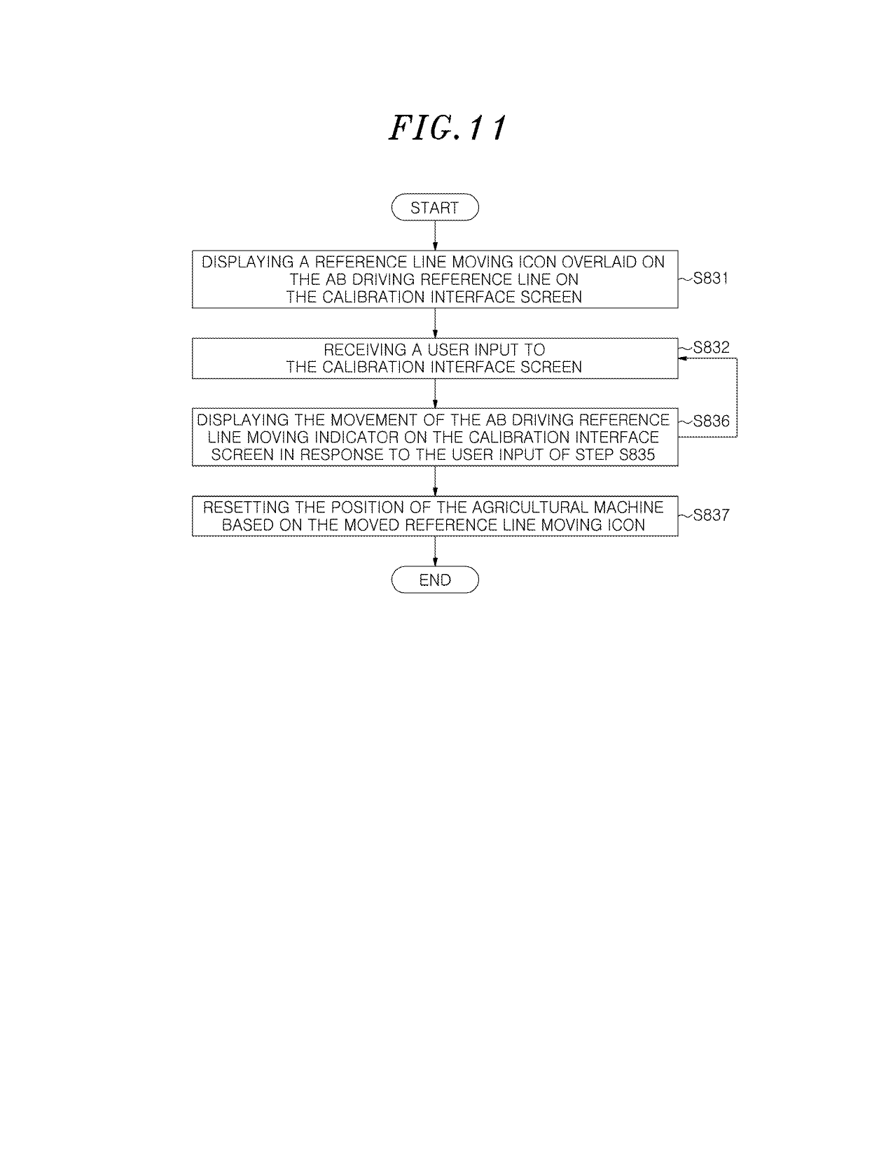

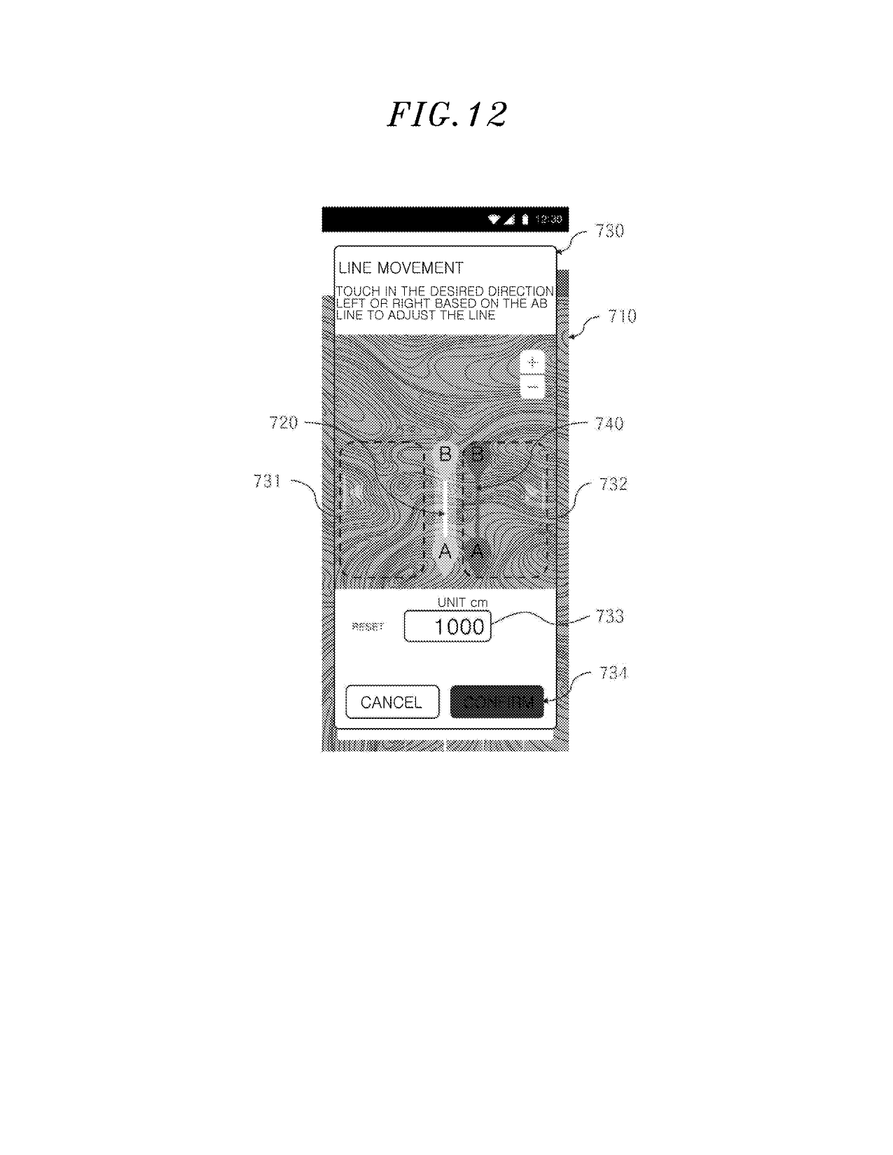

FIG. 11 depicts an illustrative embodiment of a calibrating step (S830) shown in FIG. 9 according to various embodiments of the present disclosure described herein, and FIG. 12 illustrates an exemplary screen displaying a reference line moving icon overlaid on the AB driving reference line shown in FIG. 10.

Referring to FIG. 11, step S830 may begin with step S831 of displaying a reference line moving icon overlaid on the AB driving reference line on the calibration interface screen.

For example, when the user inputs a calibration button 713 that triggers calibration displayed on the map image 710, a modal 730 for calibration may be overlaid and displayed on the map image 710 as shown in FIG. 12. The AB driving reference line 720 and the reference line moving icon 740 may be displayed on the modal 730. In one embodiment, the modal 730 may be a pop-up window.

In the step of displaying the AB driving reference line 720 on the map 710 on the calibration interface screen provided by the second display or the user terminal based on the GPS coordinates, when the calibration button 713 for triggering calibration displayed on the map 710 is input, the modal 730 for calibration is overlaid and displayed on the map 710. The AB driving reference line 720, the reference line moving icon 740, and the AB driving reference line moving indicator 750 are displayed on the modal 730 for calibration, and the left area 731 and the right area 732 are located on the modal 730.

In step S831, the AR system 20 receives a user input to the calibration interface screen, and in step S832, the AR system 20 may display the movement of the reference line moving icon on the output device 141 of the second display unit 140 in response to the user input to the calibration interface screen.

In various embodiments of the present disclosure, the degree of calibration may be based on the number of touches or the duration of the user's touch input. For example, when the user touches the left area 731 of the modal 730 once, the agricultural vehicle may be calibrated to be positioned 1 cm to the left relative to the AB driving reference line 720. As another example, when the user maintains a touch on the left area 731 for 1 second, the agricultural vehicle may be calibrated to be positioned 1 cm to the left relative to the AB driving reference line 720.

In one embodiment of the present disclosure, the AR system 20 may further display arrow objects for intuitively recognizing the left area 731 and the right area 732. In another embodiment, the AR system 20 may display separate button objects with visually partitioned touch areas, different from the left area 731 and the right area 732.

In some embodiments, the vertical length of the set areas 731 and 732 may correspond to the vertical length of the AB driving reference line 720 on the display screen. For example, the height of the areas 731 and 732 may be the length of the AB driving reference line 720. The horizontal length of the set areas 731 and 732 may be the gap between the AB driving reference line 720 and the edge of the screen.

In various embodiments of the present disclosure, in response to an input to the left area 731 or the right area 732 on the modal 730, the AR system 20 may move and display the reference line moving icon 740.

Through such movement of the reference line moving icon 740 and comparison with the AB driving reference line 720, the user can intuitively and accurately match the actual position of the agricultural vehicle to the map image 710.

When the user completes calibration, the AR system 20 may reset the position reference of the agricultural vehicle based on the reference line moving icon 740 moved on the output device 141. Completion of calibration may be identified by receiving an input to the completion button 734 displayed on the modal 730.

In various embodiments of the present disclosure, a movement distance number field 733 may be displayed on the modal 730. The movement distance number field 733 may numerically express the movement distance of the reference line moving icon 740 moved by the user's input.

In one embodiment of the present disclosure, the user may directly enter a numerical value into the movement distance number field 733 to move the reference line moving icon 740, instead of providing input to the left area 731 or the right area 732 of the modal 730. In addition, when the AR system 20 detects a touch input to the 'RESET' button disposed adjacent to the movement distance number field 733, it may reset the movement of the reference line moving icon 740.

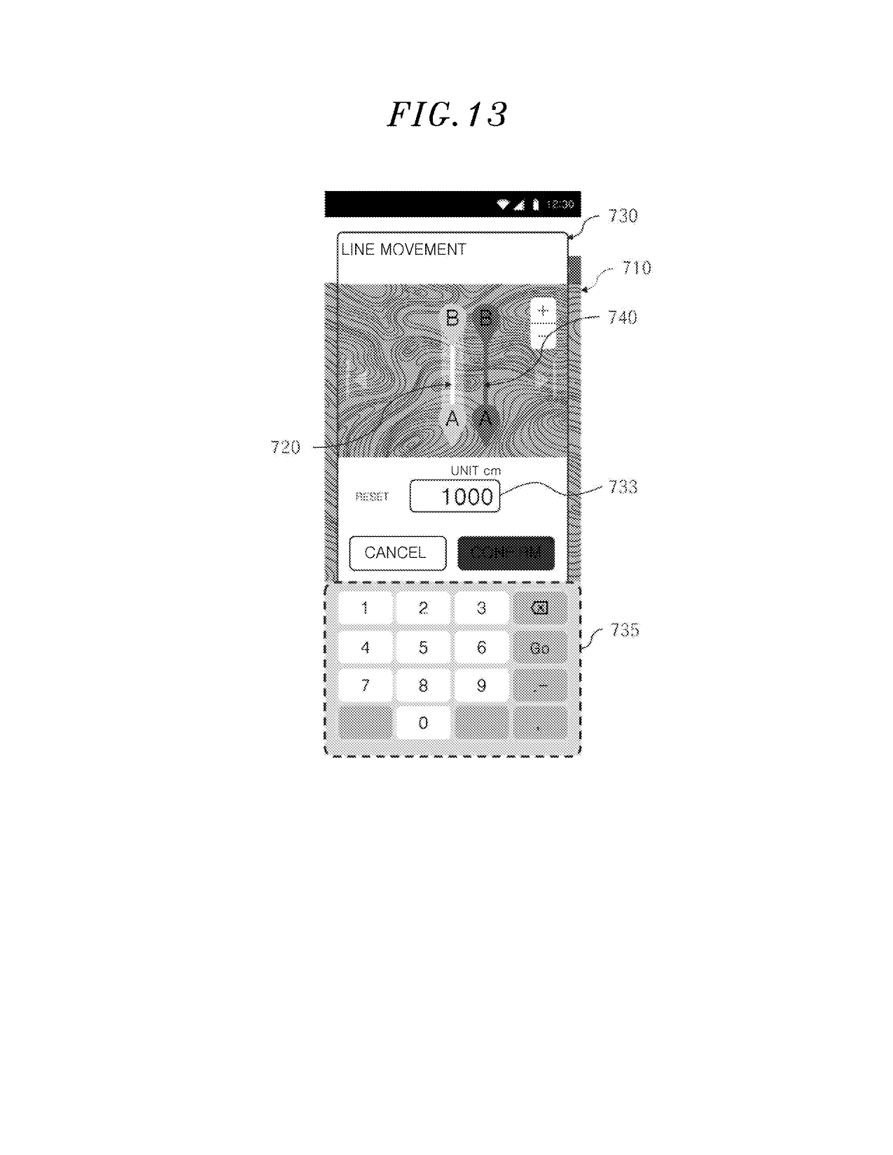

FIG. 13 illustrates direct input of a movement distance of a reference line moving icon 740 on a calibration interface screen, according to various embodiments of the present disclosure.

Referring to FIG. 13, when the user's touch input to the movement distance number field 733 as a text box is received, the AR system 20 may further display a numeric pad 735 capable of numeric input at the bottom of the calibration interface screen. The user may directly input the movement distance of the reference line moving icon 740 through input to the numeric pad 735.

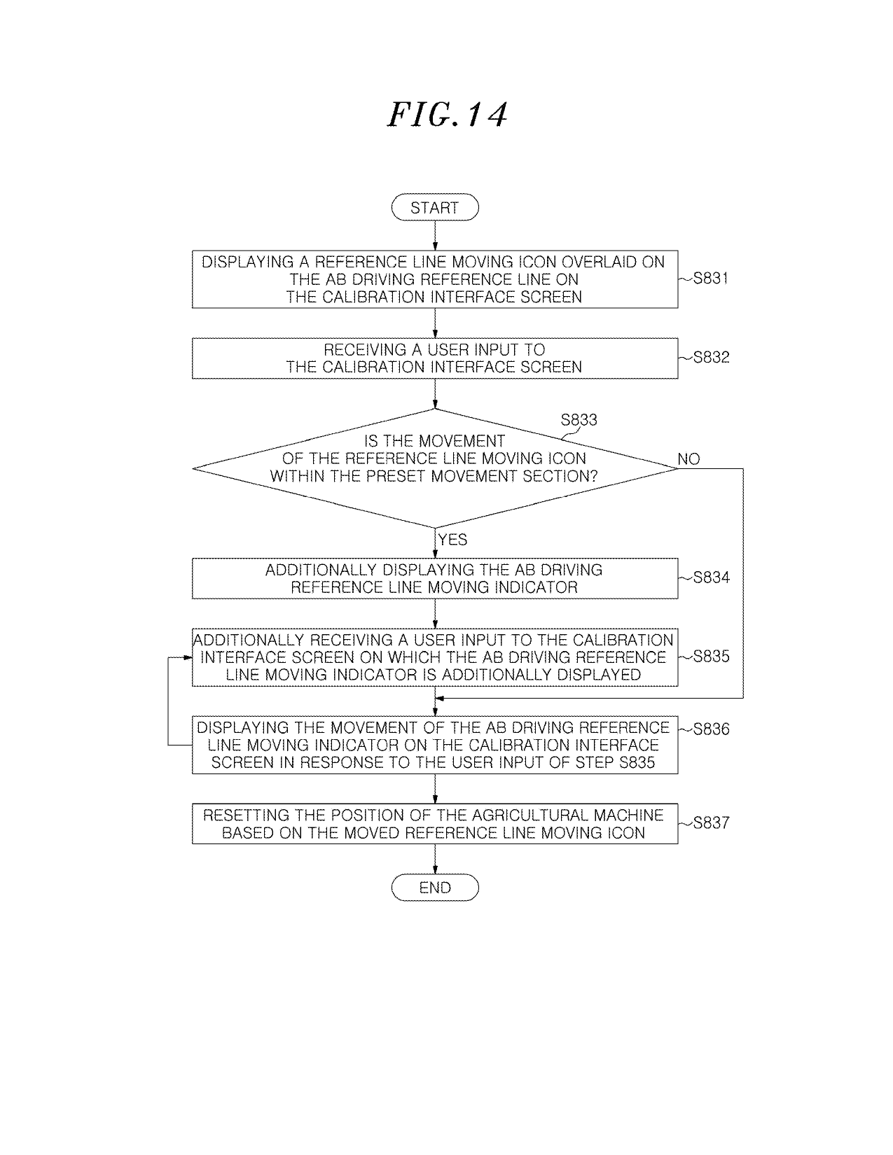

FIG. 14 is a detailed flowchart of a calibrating step S830 according to various embodiments of the present disclosure. The detailed steps of FIG. 14 are similar to the detailed steps of FIG. 11, and may further include steps S833 through S835 additionally performed between step S832 of receiving a user input to the calibration interface screen shown in FIG. 11 and step S836 of displaying the movement of the reference line moving icon on the calibration interface screen in response to the user input.

Referring to FIG. 14, in step S832, after the AR system 20 receives a user input to the calibration interface screen, the process may proceed to step S833 of determining whether the immediately preceding movement of the reference line moving icon is within the preset movement section.

Here, the preset movement section may refer to a degree to which the user has difficulty visually recognizing the movement due to the scale limitations of the map, when the movement distance of the reference line moving icon 740 is fine in units of centimeters. For example, the preset movement section may mean within 100 cm with respect to the AB driving reference line 720.

When it is determined in step S833 that the immediately preceding movement of the reference line moving icon is within the preset movement section, the process may proceed to step S834. This is because when the movement of the reference line moving icon 740 is within the preset movement section, the moved reference line moving icon 740 may be difficult for the user to visually recognize in comparison with the AB driving reference line 720 displayed on the map image 710, and therefore the AB driving reference line moving indicator 750 is additionally displayed to assist the user.

When it is determined in step S833 that the immediately preceding movement of the reference line moving icon is outside the preset movement section, the process may proceed directly to step S836, as the movement of the reference line moving icon 740 is sufficiently large to be visually recognized by the user without the indicator.

In step S834, when the reference line moving icon 740 is moved within the preset movement section, for example within 100 cm, the AR system 20 may further display the AB driving reference line moving indicator 750. In one embodiment of the present disclosure, the AB driving reference line moving indicator 750 may be displayed in a partial area of the modal 730.

The AB driving reference line moving indicator 750 may include an auxiliary AB driving reference line 751 and an auxiliary moving line icon 752. The auxiliary AB driving reference line 751 is displayed at the center of the AB driving reference line moving indicator 750, and may serve as a reference for the movement of the auxiliary moving line icon 752, similar to the AB driving reference line 720.

The auxiliary moving line icon 752 may move in response to a touch input to the left area 731 and/or the right area 732 that causes the movement of the reference line moving icon 740.

According to various embodiments of the present disclosure as described above, the GUI for AB driving reference line calibration provided by the system 10 for providing an AR navigation screen for an agricultural vehicle enables fine adjustment in units of centimeters by providing the AB driving reference line moving indicator 750.

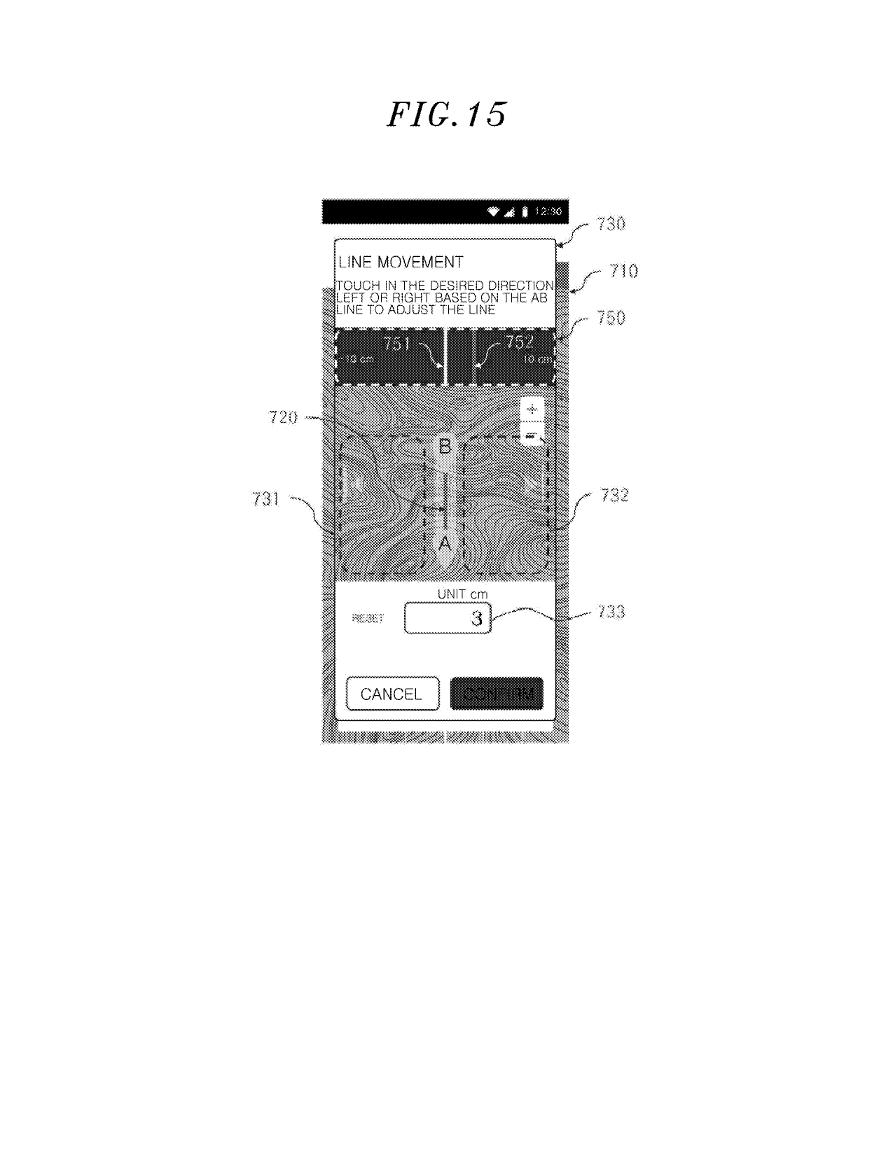

In various embodiments of the present disclosure, the AB driving reference line moving indicator 750 may provide a different scale depending on the movement distance of the auxiliary moving line icon 752 or the reference line moving icon 740. For example, in the example of FIG. 15, the AB driving reference line moving indicator 750 may provide a scale in which the auxiliary moving line icon 752 moves 10 cm when moved to both ends of the calibration interface screen.

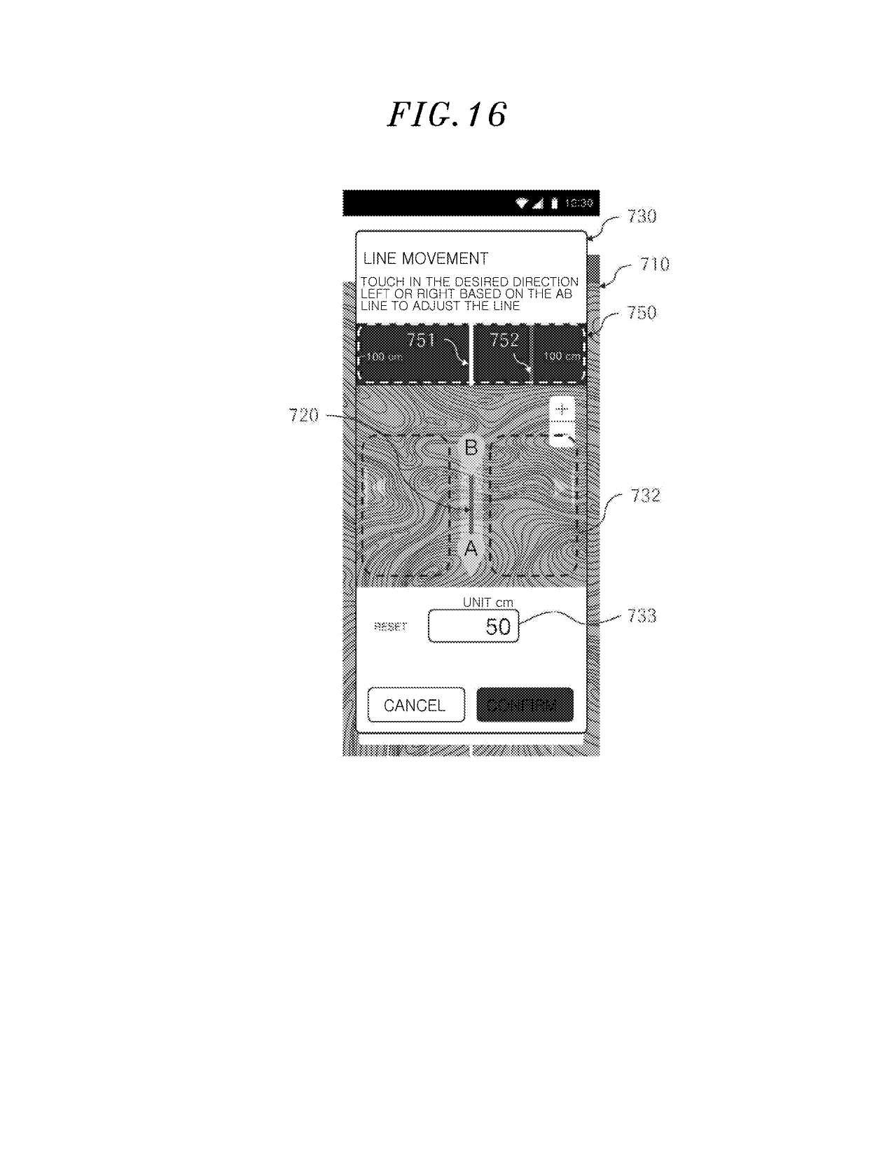

FIG. 15 illustrates a calibration interface screen on which an auxiliary moving line icon 752 and an auxiliary AB driving reference line 751 are displayed, according to various embodiments of the present disclosure, and FIG. 16 illustrates direct input of a movement distance of the auxiliary moving line icon 752 on the calibration interface screen of FIG. 15.

FIG. 15 illustrates an example in which the auxiliary moving line icon 752 has moved 3 cm to the right relative to the auxiliary AB driving reference line 751. As another example, in the example of FIG. 16, the AB driving reference line moving indicator 750 may provide a scale in which the auxiliary moving line icon 752 moves 100 cm when moved to both ends of the calibration interface screen. FIG. 16 illustrates an example in which the auxiliary moving line icon 752 has moved 50 cm to the right relative to the auxiliary AB driving reference line 751.

In one embodiment, the AR system 20 may interoperate with a plurality of agricultural vehicles. In other words, the AR system 20 may establish communication with a plurality of agricultural vehicles. The AR system 20 may acquire map data from the agricultural vehicle among the plurality of agricultural vehicles that has the best communication connection quality, i.e., the lowest latency.

According to various embodiments of the present disclosure as described above, the GUI for AB driving reference line calibration provided by the system 10 for providing an AR navigation screen for an agricultural vehicle can provide a smoother user experience by providing an alternative technology for cases in which smooth acquisition of satellite-captured map data is difficult.

When the navigation system 110 accurately matches the GPS location with the map displayed on the display through the calibration operation S800 in the autonomous driving environment of the agricultural vehicle, it may generate an AR navigation screen reflecting the calibration result. The navigation system 110 may then modify the driving error information of the agricultural vehicle according to the calibration result, and generate the AR navigation screen representing the modified driving error of the agricultural vehicle (step S700). In the AR navigation screen representing the modified driving error, the AR graphic object 304 indicating the modified driving error is relatively reduced compared to before the calibration. For example, when the modified driving error is 0 m, the AR graphic object 304 is removed from the AR navigation screen representing the modified driving error. Accordingly, the calibration operation S800 may be treated as an operation of removing the AR graphic object 304 from the existing AR navigation screen.

It will be apparent to those skilled in the art that the agricultural vehicle 20 may include other components. For example, the agricultural vehicle 20 may include other hardware elements necessary for the operations described herein, including input devices for data entry and output devices for printing or displaying other data.

When the embodiment of the present disclosure is implemented using hardware, application specific integrated circuits (ASICs), digital signal processors (DSPs), digital signal processing devices (DSPDs), programmable logic devices (PLDs), and field programmable gate arrays (FPGAs) configured to perform the embodiment of the present disclosure may be provided in the processor of the present disclosure.

Meanwhile, the above-described method may be written as a program that can be executed by a computer and may be implemented in a general-purpose digital computer that can execute the program using computer-readable media. In addition, a data structure used in the above-described method can be recorded on a computer-readable storage medium through various means. It should be understood that program storage devices that can be used to describe storage devices including executable computer code for performing various methods of the present disclosure do not include temporary objects such as carrier waves or signals. The computer-readable storage media include storage media such as magnetic recording media (e.g., ROM, floppy disks, and hard disks) and optical readable media (e.g., CD-ROM and DVD).

The above-described embodiments are implemented by combining the components and features of the present disclosure in a predetermined form. Each component or feature should be considered as optional unless explicitly stated otherwise. Each component or feature may be practiced in a form in which it is not combined with other components or features. In addition, embodiments of the present disclosure may be configured by combining some components and/or features. The order of the operations described in the embodiments of the present disclosure may be changed. Some components or features of any embodiment may be included in other embodiments or may be replaced by the corresponding components or features of other embodiments. It is apparent that embodiments may be configured by combining claims that do not have an explicitly cited relationship in the claims, and may be included as new claims through amendments after filing.

It will be apparent to those skilled in the art that the present disclosure may be embodied in other specific forms without departing from the technical spirit and essential features of the present disclosure. Accordingly, the above embodiments should be considered in all respects as illustrative rather than restrictive. The scope of the present disclosure shall be determined by a reasonable interpretation of the appended claims and all changes within the equivalent scope of the present disclosure.

Embodiments of the present disclosure are expected to have high applicability in the agricultural vehicle industry, as they can effectively convey various information related to agricultural vehicles from a visual perspective through augmented reality technology.

What is claimed is:

1. A method for providing an augmented reality (AR) navigation screen, performed by a system installed in an agricultural vehicle, the method comprising:
obtaining GPS location information indicating a GPS location of the agricultural vehicle from a GPS module;
obtaining navigation information of the agricultural vehicle, wherein the navigation information includes driving guidance route information describing a driving guidance route along which the agricultural vehicle is to travel;
obtaining, from a camera module, a driving environment image capturing a driving environment in which the agricultural vehicle is traveling;
calculating driving-related information of the agricultural vehicle based on the GPS location information of the agricultural vehicle obtained while the agricultural vehicle is traveling;
obtaining a difference between the driving guidance route and an actual driving route of the agricultural vehicle as driving error information of the agricultural vehicle;
generating at least one AR graphic object visually representing at least one of the navigation information, the driving-related information of the agricultural vehicle, and the driving error information; and
generating an AR navigation screen in which the at least one AR graphic object is arranged on the driving environment image.

2. The method of claim 1, wherein the generating of the AR navigation screen comprises:
identifying a location on the driving environment for an AR graphic object representing two or more types of the navigation information, the driving-related information, and the driving error information, wherein the location of the AR graphic object is a location on the driving environment image;
defining a shape space for the AR graphic object based on the identified location, and generating a shape of the AR graphic object based on the defined shape space; and
overlaying the shape of the AR graphic object onto the identified location on the driving environment image to generate the AR navigation screen in which the shape of the AR graphic object is represented on the driving environment image.

3. The method of claim 2, wherein the AR graphic object includes a first graphic object visually representing the driving guidance route, and
wherein the identifying of the location of the AR graphic object on the driving environment image comprises:
identifying a location of the first graphic object based on the GPS location information of the agricultural vehicle, map information of a geographical area including the GPS location of the agricultural vehicle, driving heading information of the agricultural vehicle, and parameters of the camera module, and
wherein the identifying of the location of the first graphic object comprises:
mapping a 2D coordinate system for the driving environment image and a 3D coordinate system for a virtual 3D world;
calculating a 3D location of the driving guidance route in the virtual 3D world based on the map information and the driving guidance route; and
changing the 3D location of the driving guidance route to a 2D location of the driving guidance route through a mapping relationship between the 2D coordinate system and the 3D coordinate system, and identifying the changed 2D location as the location of the first graphic object.

4. The method of claim 3, wherein the mapping of the 2D coordinate system for the driving environment image and the 3D coordinate system for the virtual 3D world comprises:
setting intrinsic parameters of the camera module to map 2D coordinates of the driving environment image and virtual 3D world coordinates, wherein the intrinsic parameters of the camera module include at least one of a principal point, a focal length, and distortion coefficients.

5. The method of claim 3, wherein the driving-related information includes at least one of driving mode information, a driving route traveled along the driving guidance route, a driving distance according to the driving route, a driving time, a real-time driving speed of the agricultural vehicle at a current location at a time of generating the AR navigation screen, a driving azimuth angle of the agricultural vehicle, and work coverage area information, and
wherein the AR graphic object further includes at least one of a second graphic object visually representing the work coverage area information resulting from driving of the agricultural vehicle, a third graphic object visually representing a driving direction of the agricultural vehicle, and a fourth graphic object visually representing the driving error information, and
wherein the identifying of the location of the AR graphic object on the driving environment image comprises:
when the AR graphic object includes the second graphic object, identifying a location of the second graphic object based on the identified location of the first graphic object, the driving route, the driving distance, and pre-stored unit work coverage area information per unit driving distance;
when the AR graphic object includes the third graphic object, identifying a location of the third graphic object based on the identified location of the first graphic object and the driving heading information of the agricultural vehicle; and
when the AR graphic object includes the fourth graphic object, identifying a location of the fourth graphic object based on the identified location of the first graphic object and the driving error information; and
wherein the locations of the second graphic object, the third graphic object, and the fourth graphic object are locations on the 2D coordinate system for the driving environment image.

6. The method of claim 1, wherein the generating of the AR navigation screen further comprises:
generating a map view area indicating the GPS location information of the agricultural vehicle, a map image, the driving heading information of the agricultural vehicle, work coverage area information, and a surrounding area of the agricultural vehicle;
generating an error view area describing a current driving error of the agricultural vehicle at the time of generating the AR navigation screen based on the driving error information; and
overlaying at least one of the map view area and the error view area onto the driving environment image to generate the AR navigation screen in which at least one of the map view area and the error view area is displayed as an overlay.

7. The method of claim 1, wherein the generating of the AR navigation screen further comprises:
displaying driving distance information of the agricultural vehicle within the calculated driving-related information, a work coverage area, and driving time information in a first sub-area of the navigation screen;
displaying driving mode information of the agricultural vehicle in a second sub-area of the navigation screen; and
displaying contents of a driving guidance message within the obtained navigation information in a sub-area of the navigation screen, wherein the driving guidance message includes at least one of a driving instruction, a work instruction, or a warning message.

8. The method of claim 1, wherein the method further comprises:
displaying an AB driving reference line on a calibration interface screen including a map image on which the agricultural vehicle is shown based on the GPS location of the agricultural vehicle, and calibrating GPS coordinates of the agricultural vehicle to actual coordinates of the agricultural vehicle using the AB driving reference line, thereby removing the driving error of the agricultural vehicle;
wherein the AB driving reference line is at least a partial route among the driving guidance route in the navigation information, and
wherein the AR graphic object indicating the driving error of the agricultural vehicle modified according to a calibration result on the AR navigation screen is relatively reduced in size or removed to indicate the driving error of the agricultural vehicle modified according to the calibration result on the AR navigation screen.

9. The method of claim 1, wherein the calculating comprises:
displaying a reference line moving icon overlaid on an AB driving reference line on an interface screen for calibration;
moving the reference line moving icon displayed on the interface screen for calibration in response to a user input to the interface screen for calibration; and
when the reference line moving icon displayed on the interface screen for calibration is moved within a preset movement section in response to the user input to the interface screen for calibration, additionally displaying an AB driving reference line moving indicator on the interface screen for calibration,
wherein the AB driving reference line moving indicator is located in an outer area of a left area and a right area on the interface screen for calibration, and when the movement of the reference line moving icon is made outside the preset movement section, the display of the AB driving reference line moving indicator is deactivated,
wherein the user input to the interface screen for calibration is a user's touch input for a preset area based on a touch interface embedded in the interface screen for calibration, and the left area or the right area relative to the AB driving reference line on the interface screen for calibration is an area set to receive the user's touch input, and when the user's touch input is made on the left area, the reference line moving icon is moved to the left are by a preset distance, and when the user's touch input is made on the right area, the reference line moving icon is moved to the right area by a preset distance,
wherein the AB driving reference line moving indicator includes an auxiliary AB driving reference line, which becomes a reference for moving an auxiliary moving line icon, and the auxiliary moving line icon, and the auxiliary AB driving reference line and the auxiliary moving line icon are displayed together on the interface screen for calibration along with the AB driving reference line, and
wherein the auxiliary AB driving reference line is displayed in a center of the AB driving reference line moving indicator, and the auxiliary moving line icon moves in response to a touch input to the left area or the right area causing the movement of the reference line moving icon in the AB driving reference line moving indicator, wherein the preset movement section corresponds to a movement distance for which movement of the reference line moving icon is visually difficult to recognize on the interface screen for calibration.

10. The method of claim 9, wherein, in the displaying of the AB driving reference line on the calibration interface screen including a map image on which the agricultural vehicle is shown based on the GPS location of the agricultural vehicle:
when a calibration button for triggering calibration displayed on a map is input, a modal for calibration is overlaid and displayed on the map, and
the AB driving reference line, the reference line moving icon, and the AB driving reference line moving indicator are displayed on the modal for calibration, and the left area and the right area are located on the modal, wherein the modal for calibration is overlaid and displayed on the map image.

11. A non-transitory computer-readable recording medium on which a computer program for performing the method for providing an augmented reality (AR) navigation screen according to claim 1 is recorded.

12. A navigation system installed in an agricultural vehicle to generate an augmented reality (AR) navigation screen, the navigation system comprising a processor and a memory storing instructions, wherein the instructions, when executed by the processor, cause the navigation system to perform:
obtaining GPS location information indicating a GPS location of the agricultural vehicle from a GPS module;
obtaining navigation information of the agricultural vehicle, wherein the navigation information includes driving guidance route information describing a driving guidance route along which the agricultural vehicle is to travel;
obtaining, from a camera module, a driving environment image capturing a driving environment in which the agricultural vehicle is traveling;
calculating driving-related information of the agricultural vehicle based on the GPS location information of the agricultural vehicle obtained while the agricultural vehicle is traveling;
obtaining a difference between the driving guidance route and an actual driving route of the agricultural vehicle as driving error information of the agricultural vehicle; and
generating at least one AR graphic object visually representing at least one of the navigation information, the driving-related information of the agricultural vehicle, and the driving error information, and generating an AR navigation screen in which the at least one AR graphic object is overlaid on the driving environment image.
